(19) United States
(12) Patent Application Publication
(10) Pub. No.: US 2014/0171327 A1
(43) Pub. Date: Jun. 19, 2014

(54) NOVEL COMPOSITE

(71) Applicant: REVOLYMER (U.K.) LIMITED, Deeside, Flintshire (GB)

(72) Inventors: Stephen Armstrong, Chester (GB); Terence Cosgrove, Portishead (GB); John Jeffrey Gerrard, Chester (GB); Melanie Jane Hughes, Chester (GB); David Alan Pears, Stockport (GB)

(73) Assignee: REVOLYMER (U.K.) LIMITED, Deeside, Flintshire (GB)

(21) Appl. No.: 14/111,907

(22) PCT Filed: Apr. 13, 2012
(86) PCT No.: PCT/GB2012/050823

§ 371 Date: Feb. 24, 2014

(30) Foreign Application Priority Data
Apr. 15, 2011 (GB) 1106409.4

(51) Int. Cl. C11D 3/48; C05G 3/00; A01N 25/26

(52) U.S. Cl. CPC C11D 3/48; A01N 25/26; C05G 3/0029
USPC 504/359; 510/382; 510/221; 510/224; 510/337; 510/276; 71/27

(57) ABSTRACT

The present invention relates to a novel composite including one or more core units having an ionic strength-responsive hydroxyl-functional vinylic co-polymeric coating, to a process for the preparation of such a composite, to formulations including the same and their use in a variety of industrial applications.

The present invention relates to a novel composite comprising one or more core units having an ionic strength-responsive hydroxyl-functional vinylic co-polymeric coating, to a process for the preparation of such a composite, to formulations comprising the same and their use in a variety of industrial applications.

The practice of protecting active agents from an incompatible environment by physical separation, for example, by encapsulation is well established. Separation techniques may be employed for a wide variety of reasons, including protecting active agents from oxidation, preventing volatile losses, preventing chemical reaction or improving the handling characteristics of difficult to handle active agents and materials. Even when the objective of the encapsulation is the isolation of the core from its surroundings, the protective coating or shell must be ruptured at the time of desired action. The rupturing of the protective coating or shell is typically brought about through the application of chemical and physical stimuli such as pressure, shear, melting, response to changing solvent conditions, solvent action, enzyme attack, chemical reaction and physical disintegration.

The present invention is concerned with the use of protective polymeric coatings which, when applied to one or more core units comprising an active agent form a composite, designed to, rupture as a consequence of a change in solvent conditions, to give an aqueous solvent system of low ionic strength and high water (solvent) activity. The use of such polymeric coatings advantageously enables a wide variety of active agents to be co-formulated with other active and/or non-active agents with which they would otherwise be incompatible, i.e. their inclusion in the same formulation would, in the absence of a protective coating, undesirably result in the chemical degradation of one or more of the active agents present.

By way of example, the composites of the present invention may be employed in solid and liquid cleaning formulations, including bleaching compositions. Bleaching compositions frequently contain peroxy acid oxidising (or bleaching) agents of general formula (1):

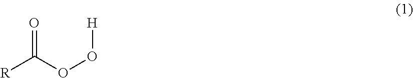

where R is a linear, branched or cyclic, aliphatic or aromatic, saturated or unsaturated, substituted or unsubstituted organic moiety containing two or more carbon atoms. Peroxy acids act as bleaching agents upon decomposition to afford oxygen radicals or “active oxygen” as follows:

2R—CO—O—O—H→2R—CO—OH+2O⁻

Decomposition may be initiated by exposure to various physical (mechanical and/or thermal) stresses, is facilitated by the presence of water and may be strongly exothermic.

Phthalimido peroxy alkanoic acids of formula (2) are an example of a class of commercially available monoperoxy acids that are commonly used in cleaning formulations:

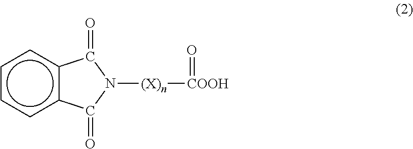

where X is a linear or branched, substituted or unsubstituted hydrocarbon chain having at least one carbon atom and n is an integer, typically in the range from 1 to 5.

Phthalimido peroxy hexanoic acid (PAP) of formula (3):

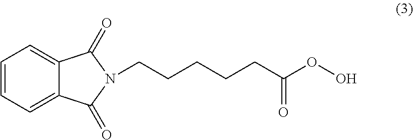 [SMILES: O=C(CCCCCN1C(=O)c2ccccc2C1=O)OO]

is an example of a phthalimido peroxy alkanoic acid that has been shown to possess particularly good bleaching properties (“PAP: the bleaching agent for low temperature washing”; Elena Negri, Ausimont S.p.A., Italy—page 29 of “comitato italiano dei derivati tensioattivl”—ATTI delle 9^{e} Giornate C D, Venezia, 13-15 giugno 2001).

Peroxy acid bleaching agents are employed in a variety of cleaning formulations including laundry and dishwasher cleaning compositions. Such compositions typically comprise, in addition to a bleaching agent, a number of other active and non-active components such as surfactants, enzymes and mixtures thereof. The compositions may be in liquid or solid form. The inclusion of bleaching agents such as peroxy acids in the same composition with enzymes and other components sensitive to oxidation, although desirable from a cleaning perspective, is problematic since these species tend to react with one another resulting in the loss of active oxygen from the bleaching agent and denaturing of the enzyme.

This incompatibility problem has previously been addressed by formulating and packaging the bleaching agent and the enzyme in such a way that the two components are separated (so-called two chamber products) and only mixed either upon dispensing or upon dissolution of a protective pouch, for example as used in the commercially available products Fairy Platinum (Proctor & Gamble, Cincinnati, USA) and Finish Quantum (Reckitt Benckiser, Hull, UK) dishwasher tablets. Although such products have the capability to act upon both bleachable and enzymatically degradable stains, this is only achieved with significant additional manufacturing and packaging costs compared to single chamber products. Packaging methods of this type place many practical constraints on total product design; limiting freedom in active agent selection and the need to incorporate active agents into specific compartments.

It would be highly desirable to provide a single chamber product capable of housing two or more otherwise incompatible active agents such as a bleaching agent and an enzyme, whilst maintaining or improving the properties possessed by the product, such as providing enhanced cleaning properties.

The coating and encapsulation of detergent components with various inorganic and organic materials has been documented in the art. For example, WO94/15010 (The Proctor & Gamble Company) discloses a solid peroxy acid bleach precursor composition in which particles of peroxy acid bleach precursor are coated with a water-soluble acid polymer, defined on the basis that a 1% solution of the polymer has a pH of less than 7.

WO94/03568 (The Proctor & Gamble Company) discloses a granular laundry detergent composition having a bulk density of at least 650 g/l, which comprises discrete particles comprising from 25-60% by weight of anionic surfactant, inorganic perhydrate bleach and a peroxyacid bleach precursor, wherein the peroxy acid bleach precursor is coated with a water soluble acidic polymer.

U.S. Pat. No. 6,225,276 (Henkel Kommanditgesellschaft auf Aktien) discloses a solid particulate detergent composition comprising a coated bleaching agent that dissolves in water irrespective of pH, a bleach activator coated with a polymeric acid that only dissolves at pH values above 8, and an acidifying agent.

U.S. Pat. No. 5,972,506 (BASF Aktiengesellschaft) discloses microcapsules containing bleaching agents. The microcapsules are obtained by polymerizing a mixture of monomers in the oil phase of a stable oil-in-water emulsion in the presence of free radical polymerization initiators.

WO97/14780 (Unilever NV) discloses an encapsulated bleach particle comprising a coating including a gelled polymer material, and a core material which is selected from a peroxygen bleach compound, a bleach catalyst and a bleach precursor. The gelled polymer has a molecular structure that is partially or fully cross-linked, such as for example, agar, alginate, carrageenan, casein, gellan gum, gelatine, pectin, whey proteins, egg protein gels and the like.

WO98/16621 (Warwick International Group Ltd) discloses a process for encapsulating a solid detergent component from an oil-in-water emulsion by forming a polymer film at the oil/water interface by condensation polymerisation. Suitable polymer films include polyamide, polyester, polysulphonamide, polyurea and polyurethane.

WO98/00515 (The Proctor & Gamble Company) discloses non-aqueous, particulate-containing liquid laundry cleaning compositions which are in the form of a suspension of particulate material comprising peroxygen bleaching agents and coated peroxygen bleach activators. The coating material is soluble in water, but insoluble in non-aqueous liquids, and is selected from water soluble citrates, sulfates, carbonates, silicates, halides and chromates.

WO93/24604 (BP Chemicals Ltd) discloses an encapsulated active substrate comprising a bleach and/or a bleach activator releasably encapsulated in a coating of an alkali metal carbonate or bicarbonate and an outer encapsulating coating of a metal salt of an inorganic salt.

U.S. Pat. No. 6,107,266 (Clariant GmbH) discloses a process for producing coated bleach activating granules in which bleach activator base granules are coated with a coating substrate and are simultaneously and/or subsequently thermally conditioned. The coating substance is selected from C₈-C₃₁ fatty acids, C₈-C₃₁ fatty alcohols, polyalkylene glycols, non-ionic surfactants and anionic surfactants.

According to a first aspect of the present invention there is provided a composite comprising one or more core units having an ionic strength-responsive hydroxyl-functional vinylic co-polymeric coating.

Such composites may be placed in liquid and solid product environments, possessing high ionic strength and low or no solvent activity, in which the polymeric coating is indefinitely stable. When the liquid and solid products are dispersed or diluted in water, to realise conditions of lowered ionic strength and higher solvent activity, the protective polymeric coating is compromised, by dissolution, dissolving, rupturing or swelling, and the core material released into the surrounding environment. The novel composites of the present invention are of potential value to numerous consumer and industrial products as further detailed herein.

The composite of the invention comprises one or more core units. The core unit may be in solid or liquid form, and may comprise single discrete particles, agglomerated particles, matrix particles and/or spheronised compositions.

When the core unit comprises one or more spheronised compositions, these may be prepared using a spheronising aid. Examples of suitable spheronising aids include microcrystalline cellulose, carboxymethyl-cellulose and hydroxyethylcellulose.

The core unit(s) typically comprise from about 10% to about 90% of the total composite mass.

The core unit(s) preferably comprise one or more active agents. The active agent may be in solid or liquid form. When the active agent is in liquid form, it is preferably adsorbed onto an inert solid prior to encapsulation. The active agent may be present in an amount from about 0.5 to 100% of the total core unit mass. Preferably, the active agent is present in an amount from about 0.5% to about 90% of the total core unit mass. The amount of active agent(s) present in the core units will be dependent upon the type of active agent employed.

Examples of suitable active agents include bleaching agents (particularly peroxy acids), bleach activators, anti-foaming agents, anti-redeposition aids, anti-microbials and biocides, enzymes, bleach catalysts, dye transfer inhibitors, optical brighteners, dyes, pigments, anti-scale and corrosion inhibiting ingredients, fragrances and perfumes, glass protectors, crop protection agents and agrochemicals such as pesticides, herbicides, insecticides, fungicides, fertilizers, hormones and chemical growth agents, and mixtures thereof.

In one embodiment of the invention the active agent is a bleaching agent or a mixture thereof. As used herein the term “bleaching agent” means a liquid or solid chemical compound that may be used to whiten or brighten various substrates and/or remove soil from them. Examples of suitable bleaching agents include mono- and diperoxy acids and mixtures thereof.

Examples of suitable monoperoxy acids include peroxybenzoic acid, ring-substituted peroxybenzoic acids, aliphatic monoperoxy acids, substituted aliphatic monoperoxy acids, mono-peroxyphthalic acids, and mixtures thereof. Preferred examples of monoperoxy acids include peroxy-alpha-naphthoic acid, peroxylauric acid, peroxystearic acid, peroxyformic acid, peroxyacetic acid, peroxypropionic acid, peroxyhexanoic acid, peroxybenzoic acid, nonylamidoperoxyadipic acid, 6-hydroxyperoxyhexanoic acid, 4-phthalimidoperoxybutanoic acid, 5-phthalimidoperoxypentanoic acid, 6-phthalimidoperoxyhexanoic acid (PAP), 7-phthalimidoperoxyheptanoic acid, N,N′-terephthaloyl-di-6-aminoperoxyhexanoic acid, and mixtures thereof.

Examples of suitable diperoxy acids include alkyl and aryl diperoxy acids, including di-peroxyphthalic acids, and mixtures thereof. Preferred examples of diperoxy acids include 1,12-diperoxydodecanedioic acid, 1,9-diperoxyazelaic acid, diperoxybrassylic acid, diperoxyseabacic acid, diperoxyoxyiso-phthalic acid, 2-decyldiperoxybutane-1,4-dioic acid, and mixtures thereof.

In a preferred embodiment, the bleaching agent is a peroxy acid as defined in formula (1) above or a mixture thereof. More preferably, the peroxy acid bleaching agent is a phthalimido peroxy alkanoic acid bleaching agent as defined in formula (2) above or a mixture thereof. Most preferably, the bleaching agent is PAP.

In one embodiment of the invention the active agent is a bleach activator or a mixture thereof. Examples of suitable bleach activators include one or more of the following:

a. Esters of phenols and substituted phenols, for example, as described in GB836988A. In one embodiment of the invention the bleach activator is phenylacetate.
b. Esters of monohydric aliphatic alcohols, for example, as described in GB836988A. In one embodiment of the invention the bleach activator is trichloroethylacetate.
c. Esters of polyhydric aliphatic alcohols, for example, as described in GB836988A. In one embodiment of the invention the bleach activator is mannitol hexaacetate.
d. Esters of mono- and disaccharides, for example, as described in GB836988A. In one embodiment of the invention the bleach activator is fructose pentaacetate.
e. Esters containing 2 ester groups, for example, as described in GB836988A. In one embodiment of the invention the bleach activator is benzaldehyde diacetate.
f. Esters of monobasic carboxylic acids, for example, as described in GB864798A. In one embodiment of the invention the bleach activator is sodium p-acetoxybenzene sulphonate.
g. N-diacylated amines, for example, as described in GB907356A and GB907358A. In one embodiment of the invention the bleach activator is diacetylethylamine.
h. N-diacylated ammonias, for example, as described in GB907356A and GB907358A. In one embodiment of the invention the bleach activator is diacetamide.
i. N-diacylated amides, for example, as described in GB907356A, GB907358A and GB855735A. In one embodiment of the invention the bleach activator is N-formyldiacetamide, N,N-diacetylaniline, or a mixture thereof.
j. N-diacylated urethanes, for example, as described in GB907356A and GB907358A. In one embodiment of the invention the bleach activator is N,N-diacetylethylurethane.
k. N-diacylated hydrazines, for example, as described in GB907356A and GB907358A. In one embodiment of the invention the bleach activator is triacetylhydrazine.
l. N-triacylated alkylene diamines, for example, as described in GB907356A and GB907358A. In one embodiment of the invention the bleach activator is N1,N1,N2-triacetylmethylenediamine.
m. N-tetraacylated alkylene diamines, for example, as described in GB907356A. In one embodiment of the invention the bleach activator is N1,N1,N2,N2-tetraacetylmethylenediamine, N1,N1,N2,N2-tetraacetylethylenediamine (TAED) or a mixture thereof.
n. N-diacyl derivatives of semicarbazide, thiosemicarbazide and dicyanodiamide, for example, as described in GB907356A and GB907358A.
o. Tetraacylated glycol-urils, for example, as described in GB124338A and GB1246339A. In one embodiment of the invention the bleach activator is 1,3,4,6-tetraacetyl glycol-uril and 1,3,4,6-tetrapropionyl glycol-uril.
p. Acyl alkyl and acyl benzene sulphonates, for example, as described in GB1147871A. In one embodiment of the invention the bleach activator is sodium 2-acetoxy-5-hexyl-benzene sulphonate.
q. Acyloxybenzene sulphonates, for example, as described in GB2143231. In one embodiment of the invention the bleach activator is sodium 3,5,5-trimethyl hexanoyloxybenzene sulphonate, sodium 2-ethyl hexanoyloxybenzene sulphonate, sodium nonanoyloxybenzene sulphonate (SNOBS) or a mixture thereof.

In an alternative embodiment of the invention, the active agent is an anti-foaming agent or a mixture thereof. Examples of suitable anti-foaming agent examples include soaps of natural or synthetic origin which have a high content of C₁₈-C₂₄ fatty acids; organopolysiloxanes and mixtures thereof with microfine, optionally silanized silica; alkyl ethoxylate non-ionic surfactants; and paraffins, waxes, microcrystalline waxes and mixtures thereof with silanized silica or bis-stearyl ethylenediamide, and mixtures thereof. In a preferred embodiment of the invention, the anti-foaming agent is a paraffin, a bis-stearyl ethylenediamide, or a mixture thereof. The anti-foaming agent is preferably loaded onto a granular, water-soluble or dispersible carrier material of the type described herein.

In an alternative embodiment of the invention, the active agent is an anti-redeposition aid or a mixture thereof. Examples of suitable anti-redeposition aids include organic polymeric compounds such as, but not limited to, ethoxylated polyamines, polycarboxylic acids, modified polycarboxylates or their salts or copolymers with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene, and mixtures thereof. Preferred commercially available anti-redeposition aids include TexCare® anionic polyester polymers (Clariant), Sokalan® polyacrylate copolymers (BASF) and Acusol® acrylic acid polymers (The Dow Chemical Co.).

In an alternative embodiment of the invention, the active agent is an antimicrobial agent or a mixture thereof. Examples of suitable antimicrobial agents include, but are not limited to, o-phenylphenol, bromonitropropane diol, tris(hydroxymethyl)nitromethane, octadecylaminidimethyltrimethoxysilylpropylammonium chloride, silver zeolite, benzoimidazole, 2-(4-thiazolyl)-2,6-dimethyl-1,3-dioxan-4-ol acetate, Hinokitiol, propene nitriles, 2,4,4′-trichloro-2′-hydroxydiphenylether, cyclopropyl-N′-(1,1-dimethylethyl)-6-(methylthio)-1,3,5-triazine-2,4-diamine, zinc oxide, 1-aza-3,7-dioxa-5-ethyl-bicyclo-(3,3,0)-octane, 2-bromo-2-nitro-1,3-propanediol, 2-(hydroxylmethyl)-2-nitro-1,3-propanediol, 2,2-dibromo-propanediamide, 2,4,4′-trichloro-2-hydroxydiphenyl ether, 4,4′-dichloro-2-hydroxydiphenyl ether, tetrakis(hydroxymethyl)phosphonium sulphate, and mixtures thereof.

In an alternative embodiment of the invention, the active agent is an enzyme or a mixture thereof. Examples of suitable enzymes include amylases, arabinosidases, bluco-amulases, cellulases, chondroitinases, cutinases, esterases, hydrolases, hemicellulases, isomerases, keratinases, lassases, lignases, lipases, lipooxygenases, lyases, malanases, mannanase, oxidases, oxidoreductases, pectinases, pentosanases, peroxidases, phenoloxidases, phospholipases, proteases, pullulanases, reductases, R-glucanases, tannases, transferases, xylanases, and mixtures thereof.

“Enzyme variants” produced, for example, by recombinant techniques are also included within the meaning of the term “enzyme” as used herein. Examples of suitable enzyme variants include those compounds disclosed in EP0251446A (Genencor), WO91/00345 (Novo Nordisk), EP0525610A (Solvay) and WO94/02618 (Gist-Brocades).

Core units comprising one or more enzymes may be produced by a variety of techniques known in the art. Suitable methods include those disclosed in DE2137042 (Novo Terapeutisk Laboratorium), U.S. Pat. No. 4,087,368 (Colgate Palmolive), U.S. Pat. No. 4,016,040 (Colgate Palmolive), U.S. Pat. No. 4,242,219 (Gist-Brocades), U.S. Pat. No. 4,009,076 (Lever Brothers), U.S. Pat. No. 4,689,297 (Miles Laboratories), UK1361387A (Novo Terapeutisk Laboratorium), U.S. Pat. No. 3,749,671 (P&G), U.S. Pat. No. 5,324,649 (Genencor) and U.S. Pat. No. 3,277,520 (Fuji Denki Kogyo Kabushiki Kai).

A number of suitable enzyme-containing core materials are commercially available; examples include Stainzyme® (amylase), Esperase® (protease), Alcalase® (protease), Termamyl® (amylase), Fungamyl® (amylase) and Lipolase® (lipase) which are available from Novozymes. Further examples include Purafect® (protease), Properase® (protease), Purastar® (Amylase), Puradex® (Cellulase) and Purabrite® (Mannanase), which are available from Genencor.

In an alternative embodiment of the invention, the active agent is a bleach catalyst or a mixture thereof. Examples of suitable bleach catalysts include transition metal bleach catalysts containing either manganese or cobalt. A preferred bleach catalyst is penta amine acetatcobalt (III) nitrate (PAAN). Further preferred types of bleach catalysts include the manganese-based complexes disclosed in U.S. Pat. No. 246,621 and U.S. Pat. No. 5,244,594 and those described in EP0549272A. Preferred ligands for use in preparing transition metal based bleach catalysts include 1,5,9-trimethyl-1,5,9-triazacyclododecane, 2-methyl-1,4,7-triazacyclononane, 2-methyl-1,4,7-triazacyclononane, 1,2,4,7-tetramethyl-1,4,7-triazacyclononane, and mixtures thereof.

In an alternative embodiment of the invention, the active agent is a polymeric dye transfer inhibiting agent or a mixture thereof. Examples of suitable polymeric dye transfer inhibiting agents include polyamine N-oxide polymers, copolymers of N-vinylpyrrolidone and N-vinylimidazole, polyvinylpyrrolidonepolymers, and mixtures thereof.

In an alternative embodiment of the invention, the active agent is an optical brighter or a mixture thereof. Examples of suitable optical brighteners include 4,4′-bis[(4-anilino-6-(N-2-hydroxyethyl-N-methylamino)-s-triazine-2-yl)amino]2,2′-stilbenedisulfonic acid, disodium salt (Tinopal 5BM-GX, Ciba-Geigy Corporation), 4,4′,-bis[(4-anilino-6-(N-2-bis-hydroxyethyl)-s-triazine-2-yl)amino]-2,2′-stilbenedisulfonic acid, disodium salt (Tinopal-UNPA-GX, Ciba-Geigy Corporation), 4,4′-bis[(4-anilino-6-morphilino-s-triazine-2-yl)amino]2,2′-stilbenedisulfonic acid, sodium salt (Tinopal AMS-GX, Ciba-Geigy Corporation), and mixtures thereof.

In an alternative embodiment of the invention, the active agent is a dye or a mixture thereof. Examples of suitable dyes include dyes that have high aesthetic effect but do not discolour laundered textiles; such as azo dyes, anthraquinone dyes, benzofuranone dyes, polycyclic aromatic carbonyl dyes containing one or more carbonyl groups linked by a quinoid system, indigoid dyes, polymethine and related dyes, styryl dyes, di- and tri-aryl carbonium and related dyes, such as diphenylmethane, methylene blue, oxazine and xanthene types; phthalocyanines, such as those di- and trisulfonated derivatives; quinophthalones, sulphur dyes and nitro-dyes, and mixtures thereof. Preferred dyes are those which possess low fastness to textiles, i.e. “non-staining” dyes.

In an alternative embodiment of the invention, the active agent is a pigment or a mixture thereof. Examples of suitable pigments include titanium dioxide, natural or synthetic mica, silica, tin oxide, iron oxide, rutile, chromium dioxide, aluminum oxide, zirconium oxide, bismuth oxychloride, and mixtures thereof.

In an alternative embodiment of the invention, the active agent is an anti-scale or corrosion inhibition ingredient, or a mixture thereof. Examples of suitable anti-scale or corrosion inhibition ingredients include amino trimethylene phosphonic acid, 1-hydroxy ethylidene-1,1-diphosphonic acid, ethylene diamine tetra (methylene phosphonic acid) sodium, ethylene diamine tetra (methylene phosphonic acid), diethylene triamine penta (methylene phosphonic acid), polyaspartic acid sodium salt, polyepoxysuccinic acid, polyacrylic acid, acrylic acid-2-acrylamido-2-methyl propane sulfonic acid copolymer, acrylic acid-2-hydroxypropyl acrylate copolymer, and mixtures thereof.

In an alternative embodiment of the invention, the active agent is a fragrance or perfume, or a mixture thereof. Examples of suitable fragrances or perfumes include those disclosed in U.S. Pat. No. 4,534,891, U.S. Pat. No. 5,112,688, U.S. Pat. No. 5,145,842 and “Perfumes Cosmetics and Soaps”, Second Edition, edited by W. A. Poucher, 1959. Preferred examples include acacia, cassie, chypre, cylamen, fern, gardenia, hawthorn, heliotrope, honeysuckle, hyacinth, jasmine, lilac, lily, magnolia, mimosa, narcissus, freshly-cut hay, orange blossom, orchids, reseda, sweet pea, trefle, tuberose, vanilla, violet, wallflower, and mixtures thereof.

In an alternative embodiment of the invention, the active agent is a glass protection ingredient. Examples of suitable glass protection ingredients include zinc, either in metallic form (such as described in U.S. Pat. No. 3,677,820) and compounds/complexes thereof; bismuth and compounds/complexes thereof (such as those described in BE860180); mixtures of zinc and bismuth (such as those described in EP2194115A); and polyalkyleneimines and/or salts or derivatives thereof (such as those disclosed in WO2010/020765.)

In an alternative embodiment of the invention, the active agent is a crop protection agent or an agrochemical including, but not limited to, pesticides, herbicides, insecticides, fungicides, (examples of which are found in WO0194001A2) fertilizers (examples of which are referenced in WO2009023235), hormones and chemical growth agents (examples of which are found in US2005197253).

The contents of the above-mentioned patents/applications are incorporated herein by reference as if each individual publication was specifically and fully set forth herein.

Particulate cores comprising an active agent may be formed by agglomeration, granulation, spheronisation and other techniques known in the art, for example as described in “Agglomeration Processes: phenomena, technologies, equipment”, Wolfgang Pietsch (2002), John Wiley & Sons.

In addition to one or more active agents, the core units may comprise one or more non-active components such as one or more suitable carriers, lubricants binders and/or fillers.

Examples of suitable carriers include macro-porous beads, preferably those prepared from a polyacrylic matrix, a polystyrene matrix, a polypropylene matrix or a silica matrix, swellable clays such as Bentonite, and cellulose derivatives such as carboxy methyl cellulose, and mixtures thereof.

Examples of suitable lubricants include ethoxylated alcohol, preferably Genapol® OX 070, block copolymers of ethylene oxide and propylene oxide, poloxamers, preferably Pluronic® block copolymers, such as Pluronic® L101 and Pluronic® L121, and Synperionc® PE/L61, and mixtures thereof.

Examples of suitable binders include polysaccharides such as microcrystalline cellulose, preferably Comprecel® M101, carboxymethyl cellulose, preferably Aquasorb® A380, hydroxyl ethyl cellulose, preferably Natrosol® 250HHR, hydroxypropyl cellulose, preferably Klucel® HCS, and ionic strength-responsive polymers as described herein, and mixtures thereof.

Examples of suitable fillers include polysaccharides such as microcrystalline cellulose, preferably Comprecel® M101, carboxymethyl cellulose, preferably Aquasorb® A380, hydroxyl ethyl cellulose, preferably Natrosol® 250HHR, and hydroxypropyl cellulose, preferably Klucel® HCS. Additional examples of fillers include inorganic materials such as talc, clays, including Bentonite clays, and salts such as sodium chloride and sodium sulphate, and mixtures thereof.

According to a preferred embodiment of present invention one or more core units comprising an active agent are coated with an ionic strength-responsive hydroxyl-functional vinylic co-polymer to form a composite. The protective coating encapsulates the core unit(s) and enables otherwise incompatible active agents to be co-formulated.

The ionic strength-responsive hydroxyl-functional vinylic co-polymer typically comprises from about 10% to about 90% of the total composite mass.

As used herein “encapsulation” means the application of a continuous polymeric coating to completely surround a small solid particle or liquid droplet to give a core-shell structure. The polymer coated particles (i.e. composites) of the invention are typically spherical (or approximately spherical) and suitably have a particle diameter (maximum dimension) in the range of from about 50 μm to about 2500 μm, preferably in the range from about 250 μm to about 1500 μm, and most preferably in the range from about 500 μm to about 1250 μm.

In a preferred embodiment of the invention, at least a portion of the core units are completely encapsulated by the ionic strength-responsive hydroxyl-functional vinylic co-polymer coating. More preferably, substantially all, or all, of the core units are completely encapsulated by the ionic strength-responsive hydroxyl-functional vinylic co-polymer coating. However, the invention also encompasses composites in which at least a portion of the core units are only partially coated, for example, composites in which at least a proportion of the core units are partially coated to a sufficient degree to still exhibit the desired functional characteristics of the invention, namely, so that the coating presents an effective barrier to the remaining components of the medium, but is soluble under conditions of low ionic strength and high water activity.

The core units are coated with one or more hydroxyl-functional vinylic co-polymers whose aqueous solubility is a function of ionic strength and water activity. The hydroxyl-functional vinylic co-polymer is preferably insoluble at high ionic strengths and soluble at low ionic strengths.

Ionic strength (I) is a measure of the concentration of ions, anions and cations, in a solution. It may be defined on a molality basis according to the following equation:

$$I = \frac{1}{2} {\sum }_{i = 1}^{n} {m}_{i} {z}_{i}^{2}$$

where the sum (Σ) is over all ions (i); zᵢ is the charge on the ion i; and mᵢ is the molality (mol/kg) of the ion i.

By way of example, preferably the hydroxyl-functional vinylic co-polymer is insoluble at an ionic strength equivalent to a solution of sodium chloride at a molarity of from about 1M to about 6M, whereas at an ionic strength equivalent below 1M, the copolymer is soluble.

In addition, the hydroxyl-functional vinylic co-polymer is preferably insoluble under conditions of low water activity, yet soluble under conditions of high water activity.

By way of example, preferably the hydroxyl-functional vinylic co-polymer is soluble at water activities of from about 60 to about 99.9% water. More preferably, the hydroxyl-functional vinylic co-polymer is soluble at water activities of from about 90 to about 99.9%.

Water activity (a_{water}) provides a measure of the association, at the molecular level, of water with other solution components. It is defined with respect to the vapour pressure of the solution (p) and the vapour of pure water (p^{o}) at the same temperature according to the following equation:

a_{water}=p/p^{o}

The closely related parameter of the chemical potential of the water (μ_{water}) may be defined with respect to the chemical potential of pure water (μ*_{water}) and the water activity (a_{water}) according to the following equation:

μ_{water}=μ*_{water}+RT·ln(a_{water})

where R is the gas constant (J/K) and T is the absolute temperature (K).

Thus an increase in water activity (a_{water}) paralleled by an increased chemical potential (μ_{water}), which is vital to the dissolution of the encapsulating polymer.

The hydroxyl-functional vinylic co-polymers used in the present invention, and the coatings formed from them, are soluble in water and some polar organic solvents and their mixtures, where the solvent system demonstrates high solvent activity, but are insoluble under conditions of low polar solvent activity. Examples of polar organic solvents in which the hydroxyl-functional vinylic co-polymers of the invention are soluble include methanol, ethanol, propanol, ethylacetate, industrial methylated spirits, and mixtures thereof.

Such co-polymers are characterised by the presence of chain pendent hydroxyl groups, and optionally other polar moieties, where:
1. The moieties may or may not be capable of dissociation (as demonstrated, for example, by carboxylic acid residues (—CO₂H⇄—CO₂⁻+H⁺)).
2. The moieties demonstrate strong attractive interactions with one another, in the absence of solvent and in the presence of apolar solvents and low activity polar solvents; i.e. the development of substantial polymer-polymer interactions.
3. The moieties demonstrate strong attractive interactions with high activity polar solvents; i.e. the development of substantial polymer-solvent interactions.

Examples of preferred hydroxyl and optional polar structural features include the following:
1. Aromatic or aliphatic primary, secondary and tertiary hydroxyl.
2. Aromatic or aliphatic carboxylic acids and salts.
3. Aromatic or aliphatic esters.
4. Aromatic or aliphatic primary or secondary amides.
5. Aromatic or aliphatic ethers.
6. Aromatic and aliphatic carbonyls.
7. Aromatic or aliphatic primary, secondary and tertiary amines and quaternary salts.
8. Aromatic or aliphatic sulphonic acids and salts.
9. Aromatic or aliphatic acetates.
10. Acetals.
11. Silanes, silanols and silanolates.
12. Aromatic or aliphatic urethanes.
13. Aromatic or aliphatic ureas.
14. Hydrazides
15. Combinations of the above moieties.

These structural elements may either be within the polymer backbone, pendant to the polymer backbone or both within and pendant to the polymer backbone. Thus a polymer matrix responsive to solvent conditions may be created according to the present invention.

Preferred ionic strength-responsive hydroxyl-functional vinylic copolymers are those having the following empirical structural formula (4):

—[A]ₘ[B]ₙ[C]ₚ— (4)

wherein,
[A] is an optional component and represents moieties which are essentially hydrophobic;
[B] is an optional component and represents moieties which are essentially polar and that have strong interaction with water;
[C] is an essential component which contains one or more hydroxyl functionalities; and
m, n and p represent the percentage molar fraction of components [A], [B] and [C] respectively, such that m+n+p=100%.

As used herein with reference to formula (4), the term “essentially hydrophobic” means a component [A] which lacks affinity for water; i.e. a component that tends to repel and not absorb water. Components of this type are typically non polar.

As used herein with reference to formula [4], the term “essentially polar” means a component [B] which has a strong affinity for water; i.e. a component that tends to dissolve in, mix with, or be wetted by water. Components of this type are typically charge-polarized and capable of hydrogen bonding.

The co-polymers of the invention contain a molar majority of component [C]. Thus p is always greater than m and n combined.

In a preferred embodiment of the invention m is preferably within the range from 0 to about 10%, more preferably from 0 to about 7% and most preferably from 0 to about 5%.

In a further preferred embodiment of the invention n is preferably within the range from 0 to about 20%, more preferably from 0 to about 15% and most preferably from 0 to about 10%.

In still a further preferred embodiment of the invention p is within the range 70 to 100%, more preferably 80 to 100% and most preferably 85 to 100%.

In one embodiment of the invention m is 0. In another embodiment of the invention, n is 0. In a preferred embodiment of the invention both m and n are 0.

The ionic strength-responsive hydroxyl-functional vinylic copolymers may also be defined by reference to their degree of polymerisation (DP), where the DP is the number of constituent monomeric units within the polymer. The DP is preferably between 25 and 5000, more preferably between 35 and 2500, and most preferably between 40 and 1000.

The term “ionic strength-responsive hydroxyl-functional vinylic copolymer” is used herein to describe a copolymer that can be derived from an addition polymerisation reaction that is, a free radical initiated process, which can be carried out in either an aqueous or non aqueous medium, of one or more olefinically unsaturated monomers.

Examples of suitable vinyl monomers which may be used to form an ionic strength-responsive hydroxyl-functional vinylic copolymer coating for use in the present invention include, but are not limited, to styrene, acrylonitrile, methacrylonitrile, vinyl halides, vinylidene halides, (meth)acrylamide, N,N-dimethyl acrylamide, vinyl polyethers of ethylene or propylene oxide, vinyl esters such as vinyl acetate, vinyl propionate, vinyl laurate and vinyl esters of versatic acid, vinyl ethers of heterocyclic vinyl compounds, alkyl esters of mono-olefinically unsaturated dicarboxylic acids and in particular esters of acrylic and methacrylic acid; vinyl monomers with hydroxyl functionality 2-hydroxy ethyl (meth)acrylate, 2-hydroxy propyl (meth)acrylate, glycerol mono(meth)acrylate, 4-hydroxy butyl (meth)acrylate, hydroxyl stearyl methacrylate, N-methylol (meth)acrylamide; polyethylene glycol 6 methacrylate (available from Cognis under the trade name Bisomer® PEM6), polyethylene glycol 6 acrylate (available from Cognis under the trade name Bisomer® PEA6), polypropylene glycol 6 acrylate (available from Cognis under the trade name Bisomer® PPA6), polypropylene glycol 5 methacrylate (available from Cognis under the trade name Bisomer® PPM5); vinyl monomers with additional functionality for interaction with the core or the media or for post functionalisation of the vinyl polymers, such as diacetone acrylamide, aceto acetoxy ethyl (meth)acrylate, glycidyl methacrylate, 2-acrylamido-2-methylpropane sulphonic acid, (meth)acrylic acid, beta carboxy ethyl (meth)acrylate, maleic anhydride, styrene sulphonic acid, sodio sulpho propyl methacrylate, itaconic acid; acidic monomers can be copolymerised as the free acid or the deprotonated salt form; non-ionic hydrophilic monomers such as methoxypolyethyleneglycol 350 methacrylate (available from Cognis under the trade name Bisomer® MPEG350MA), methoxypolyethyleneglycol 550 methacrylate, methoxypolyethyleneglycol 1000 methacrylate (available from Cognis under the trade name Bisomer® MPEG1000MA), methoxypolyethyleneglycol 2000 methacrylate (available from Cognis under the trade name Bisomer® MPEG2000MA), N,N-dimethyl ethyl amino (meth)acrylate, N,N-diethyl ethyl amino (meth)acrylate, N,N-dimethyl ethyl amino (meth)acrylate, N,N-dimethyl propyl amino (meth)acrylate, N,N-diethyl propyl amino (meth)acrylate, vinyl pyridine, amino methyl styrene, vinyl imidazole; and basic amine monomers can be polymerised as the free amine, protonated salts or as a quaternised amine salt.

In a preferred embodiment of the invention, the ionic strength-responsive polymer is an acrylic copolymer formed from a mixture of monomers selected from 2-acrylamido-2-methylpropane sulphonic acid, methyl methacrylate, 2-hydroxyethyl acrylate, hydroxyethyl methacrylate, ethyl methacrylate and n-butyl methacrylate.

Preferred ionic strength-responsive hydroxyl-functional vinylic copolymers of this invention are acrylic or vinyl copolymers, that is copolymers derived from esters of (meth)acrylic acid or vinyl acetate.

In a preferred embodiment of the invention, component [A] corresponds to formula (5) below:

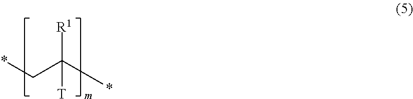

wherein each R¹ is H or CH₃;
each T is H, —OC(O)R², —C(O)OR², C₆-aromatic aryl or C₃₋₂₀ cycloalkyl optionally substituted by one of more C₁₋₆ alkyl groups;
each R² is linear or branched C₁₋₂₀ alkyl, or C₃₋₂₀ cycloalkyl optionally substituted by one or more C₁₋₆ alkyl groups; and
m is as hereinbefore defined.

In a further preferred embodiment of the invention, component [B] corresponds to formula (6) below:

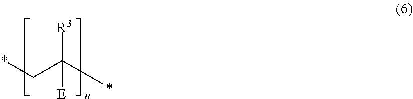

wherein each R³ is H or CH₃;
each E is selected from —OC(O)CH₂C(O)CH₃, —CN, —C(O)OCH₂CHR⁴OR⁵, —C(O)OH, —C(O)CH₂CH₂CO₂H, —C(O)OM, —C(O)CH₂CH₂CH₂SO₃M, —C(O)NHC(CH₃)₂CH₂SO₃H, —C(O)NHC(CH₃)₂CH₂SO₃M, —C(O)CH₂CH₂CO₂M, —OCH₂CH₂OC(O)CH₂C(O)CH₃, —C(O)OM, —C(O)(OCH₂CH₂)_{F}OR⁵, —Si(OM)₃, —OCH₂CH₂NR⁴, —C(O)NH₂, and —C(O)NMe₂;
M is a monovalent alkali metal; preferably sodium or potassium

### R⁴ is H or CH₃;

R⁵ is H or C₁ alkyl; preferably H or CH₃.
F is an integer from 2 to 20; and
n is as hereinbefore defined.

In a further preferred embodiment of the invention, component [C] corresponds to formula (7) below:

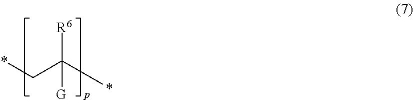

wherein each R⁶ is H or CH₃;
G is selected from —OH, —C(O)OCH₂CH₂OH, —C(O)OCHOHCH₂OH, —C(O)(OCH₂CH₂)_{F}OH, —C(O)OCH₂CHR⁷OH, —C(O)O(CH₂)₄OH, and —C(O)NR⁷CH₂OH;
each R⁷ is H or CH₃;
F is an integer from 2 to 20; and
p is as hereinbefore defined.

Particularly preferred ionic strength-responsive hydroxyl-functional vinylic copolymers are acrylic polymers derived from esters of (meth)acrylic acid and vinyl copolymers derived from vinyl acetate wherein:

m is from 0 to 6%;
n is from 0 to 6%;
p is from 96 to 100%;

### R¹ is H or CH₃;

### T is H, —OC(O)R², or —C(O)OR²;

R² is linear or branched C₁₋₄ alkyl;

### R³ is H or CH₃;

each E is selected from —OC(O)CH₂C(O)CH₃, —C(O)OH, —C(O)CH₂CH₂CO₂H, —C(O)OM, —C(O)O(CH₂)₃SO₃M, —C(O)NHC(CH₃)₂CH₂SO₃H, —C₆H₄SO₃M, —C(O)NHC(CH₃)₂CH₂SO₃M, —C(O)CH₂CH₂CO₂M, —OCH₂CH₂OC(O)CH₂C(O)CH₃, —Si(OM)₃, and —OCH₂CH₂NR⁴; —C(O)(OCH₂CH₂)_{F}OCH₃;

### R⁴ is H or CH₃;

G is selected from —OH, —C(O)OCH₂CH₂OH, —C(O)OCHOHCH₂OH, —C(O)(OCH₂CH₂)_{F}OH, —C(O)OCH₂CHR⁷OH, —C(O)O(CH₂)₄OH, and —C(O)NR⁷CH₂OH;

### R⁷ is H or CH₃; and

F is an integer from 2 to 20.

In a preferred embodiment of the invention there is provided an ionic strength-responsive hydroxyl-functional vinylic copolymer of formula (4), wherein m is from 0 to 4%, n is 0%, p is from 96 to 100%, R¹ is H, T is —OC(O)CH₃, and G is —OH; and wherein the remaining substituents are as hereinbefore defined with reference to formulae (4)-(7).

In a further preferred embodiment of the invention there is provided an ionic strength-responsive hydroxyl-functional vinylic copolymer of formula (4), wherein m is from 0 to 10%, n is from 0 to 10%, p is from 85 to 100%, R² is methyl, R³ is H or methyl, T is —OC(O)CH₃, E is —C(O)OH or —Si(OM)₃, and G is —OH; and wherein the remaining substituents are as hereinbefore defined with reference to formulae (4)-(7).

In a further preferred embodiment of the invention there is provided an ionic strength-responsive hydroxyl-functional vinylic copolymer of formula (4), wherein m is from 2 to 6%, n is 0%, p is from 94 to 100%, R¹ is H, R⁶ is H, T is H and —OC(O)CH₃, and G is —OH; and wherein the remaining substituents are as hereinbefore defined with reference to formulae (4)-(7).

In a further preferred embodiment of the invention there is provided an ionic strength-responsive hydroxyl-functional vinylic copolymer of formula (4), wherein m is 0%, n is 0%, p is 100%, R⁶ is H or CH₃ and G is —C(O)OCH₂CH₂OH; and wherein the remaining substituents are as hereinbefore defined with reference to formulae (4)-(7).

In a further preferred embodiment of the invention there is provided an ionic strength-responsive hydroxyl-functional vinylic copolymer of formula (4), wherein m is 0%, n is 0%, p is 100%, R⁶ is H or CH₃ and G is —C(O)OCH₂CH₂OH and —C(O)(OCH₂CH₂)_{F}OH; and wherein the remaining substituents are as hereinbefore defined with reference to formulae (4)-(7).

In a further preferred embodiment of the invention there is provided an ionic strength-responsive hydroxyl-functional vinylic-copolymer of formula (4), wherein m is 0%, n is 5 to 15%, p is 85 to 95%, R⁶ is H or CH₃ and G is —C(O)OCH₂CH₂OH and E is C(O)(OCH₂CH₂)_{F}OCH₃; and wherein the remaining substituents are as hereinbefore defined with reference to formulae (4)-(7).

In a further preferred embodiment of the invention there is provided an ionic strength-responsive hydroxyl-functional vinylic copolymer of formula (4), wherein m is 0%, n is from 0 to 6%, p is from 94 to 100%, R³ is H or CH₃, R⁶ is H or CH₃, E is —C(O)OH or —C(O)NHC(CH₃)₂CH₂SO₃M or —C(O)O(CH₂)₃SO₃M or —C₆H₄SO₃M, and G is —C(O)OCH₂CH₂OH; and wherein the remaining substituents are as hereinbefore defined with reference to formulae (4)-(7).

In a preferred embodiment of the invention component [A] of formula (1) represents ethylene, vinyl acetate, methyl (meth)acrylate, ethyl (meth)acrylate, propyl (meth)acrylate and butyl (meth)acrylate.

In a preferred embodiment of the invention component [B] of formula (1) represents 2-acrylamido-2-methylpropane sulphonic acid or a salt thereof, (meth)acrylic acid or a salt thereof, beta carboxy ethyl (meth)acrylate or a salt thereof, N,N-dimethyl ethyl amino (meth)acrylate, N,N-diethyl ethyl amino (meth)acrylate and/or N,N-dimethyl ethyl amino (meth)acrylate. The basic amine monomer can be present as the free amine, a protonated salt thereof or a quaternised amine salt thereof.

In a preferred embodiment of the invention component [C] of formula (1) represents 2-hydroxy ethyl (meth)acrylate, 2-hydroxy propyl (meth)acrylate and/or 4-hydroxy butyl (meth)acrylate.

The molar ratio of monomers, [A] to [B] to [C] is such that the resulting polymer is insoluble or essentially insoluble in aqueous media of low water activity, but soluble or becomes swollen and solvated (losing its mechanical integrity) in aqueous media of high water activity.

It will be appreciated that the exact level of species [B] and [C] required to cause vinylic copolymer solubility in any given high water activity media will depend on a number of factors, for example:
1. The chemical nature of components [B] and [C]; their hydrophilicity or hydrophobicity and their ability to interact with water (either through the hydrogen atoms or oxygen atom).
2. The nature and concentration of co-solutes in the media; particularly electrolytes, water soluble polymers, surfactants and organics.
3. The level of hydrophobicity of [A] in the copolymer.

It is preferred that the ionic strength-responsive hydroxyl-functional vinylic copolymers of the present invention are essentially soluble, or at least dispersible, in high water activity end use application environments, for example as encountered in both laundry and dishwasher applications, so permitting the complete release of the active agent present and the realisation of its beneficial action, whilst ensuring that no polymer residues soil (or deposit onto) the items being cleaned.

In a particularly preferred embodiment of the invention the ionic strength-responsive hydroxyl-functional vinylic copolymer is a partially hydrolysed polyvinyl acetate having an empirical structural formula (8) as follows:

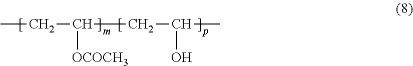

wherein, m is from 0 to 4% and p is from 96 to 100%.

Partially hydrolysed polyvinyl acetates of formula (8) may be conveniently described by their degree of hydrolysis (or saponification number), their solution viscosity (4% w/w aqueous solution at 20.0° C.) or degree of polymerisation. The degree of hydrolysis may be defined as [p/(m+p)]×100 and the solution viscosity provides a relative measure for the molar mass of the polymer.

Compounds of formula (8) are commercially available and may be obtained in partially hydrolysed grades (with a degree of hydrolysis of 65%) and fully hydrolysed grades (with a degree of hydrolysis up to 100%) with solution viscosities from 2 mPas to greater than 70 mPas. Preferred materials are those possessing a degree of hydrolysis of from 90% to 100% and solution viscosities of from 15 to 30 mPas. Particularly preferred materials are those possessing a degree of hydrolysis in the range from 96 to 100%, and most preferably 98 to 100%.

Examples of preferred commercially available hydrolysed polyvinyl acetates, both modified and unmodified grades, include R-Polymer R1130 (Kuraray), K-Polymer KL516 (Kuraray), Exceval AQ4104 (Kuraray), Exceval HR3010 (Kuraray), Gohsfimer OKS3551 (Nippon Gohsei), Mowiol 4-98 (Kuraray) and Mowiol 30-98 (Kuraray).

In a further particularly preferred embodiment of the invention the ionic strength-responsive hydroxyl-functional vinylic copolymer is a modified polyvinyl acetate having an empirical structural of formula (9), (10) or (11) as follows:

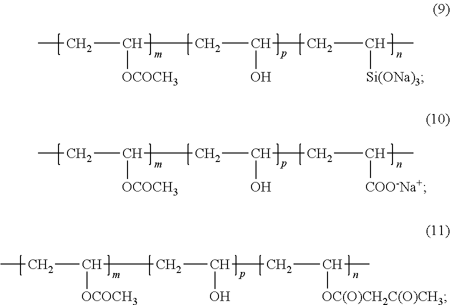

wherein, m is from 0 to 10%, n is from 1 to 10% and p is from 80 to 95%.

Compounds of formulae (9) and (10) include R-Polymer R1130 and K-Polymer KL513 and are commercially available from Kuraray Europe GmbH. An example of a compound of formula (11) is Gohsfimer OKS3551, which is commercially available from Nippon Gohsei.

In a further particularly preferred embodiment of the invention the ionic strength-responsive hydroxyl-functional vinylic copolymer is a modified polyvinyl acetate having an empirical structural of formula (12) as follows:

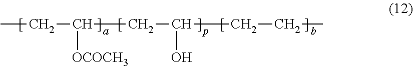

wherein, a+b=m; and m is from 2 to 6% and p is from 94 to 100%.

In a further particularly preferred embodiment of the invention the ionic strength-responsive hydroxyl-functional vinylic copolymer is poly(hydroxylethylacrylate) or poly(hydroxyethylmethacrylate).

In a further particularly preferred embodiment of the invention the ionic strength-responsive hydroxyl-functional vinylic copolymer is a copolymer of 2-hydroxylethyl acrylate or 2-hydroxyl-ethylmethacrylate and a methoxypolyethyleneglycol (meth)acrylate.

In a further particularly preferred embodiment of the invention the ionic strength-responsive hydroxyl-functional vinylic copolymer is a copolymer of 2-hydroxylethyl acrylate or 2-hydroxylethyl methacrylate and a polyethyleneglycol mono(meth)acrylate.

In a further particularly preferred embodiment of the invention the ionic strength-responsive hydroxyl-functional vinylic copolymer is a copolymer of 2-hydroxylethyl acrylate or 2-hydroxylethyl methacrylate and a carboxylic acid or sulphonic acid salt, wherein m is 0, n is from 0 to 10% and p is from 90 to 100%. For example, in one embodiment the hydroxyl-functional vinylic copolymer is co-(2-acrylamido-2-methylpropane sulphonic acid 2-hydroxyethyl methacrylate) of formula 13:

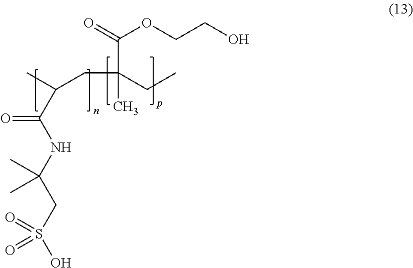

In a further particularly preferred embodiment of the invention the ionic strength-responsive hydroxyl-functional vinylic co-polymer is selected from partially hydrolysed polyvinyl acetate, fully hydrolysed polyvinyl acetate, silanolate modified hydrolysed polyvinyl acetate, ketoester modified hydrolysed polyvinyl acetate, carboxyl modified hydrolysed polyvinyl acetate, poly(hydroxyethyl-methyacrylate), poly(AMPS-hydroxyethylmethacrylate) and ethylene vinyl alcohol copolymer. Preferably, the ionic strength-responsive hydroxyl-functional vinylic co-polymer is an ethylene vinyl alcohol copolymer.

The ionic strength-responsive hydroxyl-functional vinylic copolymers of the present invention may be prepared by any polymerisation method known in the art. Preferably, the polymerisation method is carried out in water, an organic solvent or a mixture of water and an organic solvent using a free radical initiator.

Examples of suitable free radical yielding initiators include:
1. Inorganic peroxides, for example potassium, sodium or ammonium persulphate, hydrogen peroxide or percarbonates such as sodium or potassium percarbonate.
2. Organic peroxides, such as acyl peroxides, for example benzoyl peroxide; alkyl hydroperoxides such as t-butyl hydroperoxide and cumene hydroperoxide; dialkyl peroxides such as di-t-butyl peroxide; peroxy esters such as t-butyl perbenzoate; and mixtures thereof.

The peroxy compounds may advantageously be used in combination with suitable reducing agents (redox systems) such as sodium or potassium pyrosulphite or bisulphite, and iso-ascorbic acid. Azo compounds such as azoisobutyronitrile or dimethyl 2,2′-azo bis-isobutylate may also be used.

Metal compounds such as iron ethylene diamine tetraacetic acid (EDTA) may also be usefully employed as part of the redox initiator system. Other suitable free radical initiators include cobalt chelate complexes and particularly Co(II) and Co(III) complexes of porphyrins, dioximes and benzildioxime diboron compounds.

An initiator system partitioning between the aqueous and organic phases may also be employed, for example a combination of t-butyl hydroperoxide, iso-ascorbic acid and iron-ethylene diamine tetracetic acid. Preferred initiators include azo compounds such as azo-iso-butyronitrile and dimethyl 2,2′-azo bis-isobutylate, and peroxides such as hydrogen peroxide or benzoyl peroxide. The amount of initiator or initiator system is typically within the range from 0.05 to 6.00 weight percent based on the total amount of vinyl monomers used, more preferably from 0.1 to 3.0 weight percent, and most preferably from 0.5 to 2.0 weight percent based on the total amount of vinyl monomers used. Optionally chain transfer agents may be employed to limit the molecular weight of the polymer product.

If an organic solvent is used it is preferably a polar organic solvent for example a ketone, alcohol or an ether. Examples of suitable polar organic solvents are methyl ethyl ketone, acetone, methyl isobutylketone, butyl acetate, ethoxyethylacetate, methanol, ethanol, n-propanol, iso-propanol, n-butanol, amyl alcohol, diethyl glycol, diethyl glycol mono-n-butyl ether and butoxy ethanol. Most preferably, the copolymerisation reaction is carried out in an aqueous alcoholic solvent, for example, methanol, ethanol, n-propanol, iso-propanol, n-butanol, amyl alcohol, diethylene glycol or butoxyethanol, or mixtures thereof; especially aqueous ethanol and mixtures of aqueous ethanol.

When prepared by solution polymerisation, the number average molecular weight (Mₙ) of the ionic strength-responsive hydroxyl-functional vinylic copolymers is typically in the range from about 500 to about 500,000 Daltons, more preferably from about 1,000 to about 300,000 Daltons and most preferably from about 10,000 to about 150,000 Daltons.

Alternatively, the ionic strength-responsive hydroxyl-functional vinylic copolymers may prepared by emulsion or suspension polymerisation, for example as described in “Principles of Polymerisation”, 1991, (3^{rd} Edition), G. Odian, Wiley Interscience. When prepared using these techniques, the polymers typically have Mₙ values in the range from 500 to 1,000,000 Daltons.

The composite of the invention may be prepared by coating a particulate core comprising an active agent using known polymer encapsulation techniques. Preferably, the hydroxyl-functional vinylic co-polymer is applied to one or more cores comprising an active agent as an aqueous or water-rich solvent solution, dispersion, suspension or emulsion, by spray coating, and dried to give a continuous film.

In one embodiment of the invention encapsulation of the solid core is achieved by fluid bed coating or fluid bed drying.

In fluid bed coating the particulate core material is fluidised in a flow of hot air and the coating solution or latex sprayed onto the particles and dried, where the coating solution or latex may be applied by top spray coating, bottom spray (Wurster) coating or tangential spray coating, where bottom spray (Wurster) coating is particularly effective in achieving a complete encapsulation of the solid core. In general a small spray droplet size and a low viscosity spray medium promote uniform distribution of the coating over the particles.

In fluid bed drying the particulate core material may be mixed with the coating solution or latex and the resulting moist product introduced to the fluid bed dryer, where it is held in suspension in a flow of hot air, where it is dried.

Thus, in a further aspect of the present invention there is provided a process for preparing a composite comprising one or more core units having an ionic strength-responsive hydroxyl-functional vinylic co-polymeric coating, said process comprising applying a hydroxyl-functional polymeric coating to the surface of one or more core units. Said core units preferably comprise one or more active agents.

The composite of the invention may be in solid or liquid form. When the active agent is in liquid form, it is preferably adsorbed onto an inert solid compound.

For optimum coating of the particulate core it is preferred that the hydroxyl-functional vinylic co-polymer is dispersed or dissolved in a suitable solvent, in which the polymer chains are effectively solvated and individual polymer coils are highly extended.

The hydroxyl-functional vinylic co-polymer may also be applied to the particulate core as an emulsion in water or water-alcohol mixtures. Examples of suitable alcohols include methanol, ethanol and industrial methylated spirits, preferably ethanol.

On application to the particulate core the resulting coating demonstrates optimum physical characteristics; physical integrity, barrier characteristics and mechanical characteristics. In addition there may be useful non covalent interactions developed between the polymer coating and the core leading to, for example, improved integrity of the composite coated particulate in the media formulation.

In certain preferred embodiments of the invention:
1. One or more coating layers may be applied to the particulate core.
2. Each individual layer may include one or more hydroxyl-functional vinylic co-polymer.

In addition to hydroxyl-functional vinylic co-polymer(s) and solvent(s) the formulations used to coat the particulate core may also contain various known additives to facilitate the processes of coating application and subsequent film formation. Examples of suitable additives include buffers, defoamers, coalescing solvents, flow agents, rheology modifiers, surfactants, wetting agents, de-tackifiers and mixtures thereof.

The composite core-shell structure typically contains from about 10% to about 75%, preferably from about 10% to about 50%, and most preferably from about 15% to about 40%, of the ionic strength-responsive hydroxyl-functional vinylic co-polymer.

Preferably, the thickness of the ionic strength-responsive hydroxyl-functional vinylic co-polymer is from about 5 μm to about 90 μm, more preferably from about 10 μm to about 60 μm, and most preferably from about 15 μm to 40 μm.

According to a further aspect of the present invention, there is provided a composition comprising a composite comprising one or more core units having an ionic strength-responsive hydroxyl-functional polymeric coating and one or more active and/or non-active agents. Such compositions may be in solid or liquid form. In solid form, the compositions may be powders or tablets. The composites may themselves be incorporated into other solid compositions such as tablets, extrudates and agglomerates. The composites can also be suspended in aqueous and non-aqueous liquid compositions in which the ionic strength-responsive hydroxyl-functional vinylic co-polymer coating is insoluble and inert.

The composites of the invention and formulations thereof may be used in a wide variety of applications including laundry detergents, cleaning compositions and additives, autodishwashing detergents, cleaning compositions and additives, dental care compositions, hair treatments, compositions used in the agricultural industry, compositions used in the paper and paper waste industry and in cosmetic compositions. In a preferred embodiment of the invention the composite or a formulation thereof comprises a bleach, in particular a peroxy acid. Such composites and formulations thereof may be used in laundry detergents and cleaning compositions, auto-dishwashing detergents and cleaning compositions, dental care compositions, hair dyeing, decolourising and bleaching compositions, industrial decolourising and bleaching compositions, and compositions used in the processing and treatment of textiles, textile waste, paper and paper waste.

In a further preferred embodiment of the invention, there is provided a composite comprising one or more core units having an ionic strength-responsive hydroxyl-functional vinylic co-polymeric coating, or a formulation comprising the same, for use as a cleaner. Preferred cleaners include hard surface, dishwasher and laundry cleaners.

In a further preferred embodiment of the invention, there is provided a solid or liquid auto-dishwasher product comprising a composite of the invention. Said solid or liquid auto-dishwasher products are preferably intended for industrial or commercial use.

In a further preferred embodiment of the invention, there is provided a solid or liquid auto-dishwasher product comprising from about 0.5% to about 25% by weight of a composite of the invention. Most preferably, the active agent is a bleaching agent, bleach activator or an enzyme, or a mixture thereof.

In a further preferred embodiment of the invention, there is provided a solid or liquid laundry product comprising a composite of the invention.

In a further preferred embodiment of the invention, there is provided a solid or liquid laundry product comprising from about 0.5% to about 25% by weight of a composite of the invention. Most preferably, the active agent is a bleaching agent, bleach activator, enzyme, fragrance or perfume, or a mixture thereof.

The use of ionic strength-responsive hydroxyl-functional vinylic copolymers as coatings for particulate cores, such as granulated and spheronised PAP, has proven surprisingly beneficial in allowing the development of novel storage stable liquid and solid cleaning product formulations, from which various actives may be released in the wash environment to realise their individual benefits.

Furthermore, by tuning the composition of these ionic responsive copolymers, the coating thickness and the water activity of the media, it is possible to build in some control over the “trigger point” and speed at which the active agent is released from the core into the wash environment.

A further aspect of the invention relates to ionic strength responsive hydroxyl-functional vinylic copolymers of formula (4) as described above. Preferred embodiments described above apply equally to this aspect of the invention. A further aspect of the invention relates to a process of preparing such ionic strength responsive hydroxyl-functional vinylic copolymers.

The present invention is described with reference to the following figures, wherein:

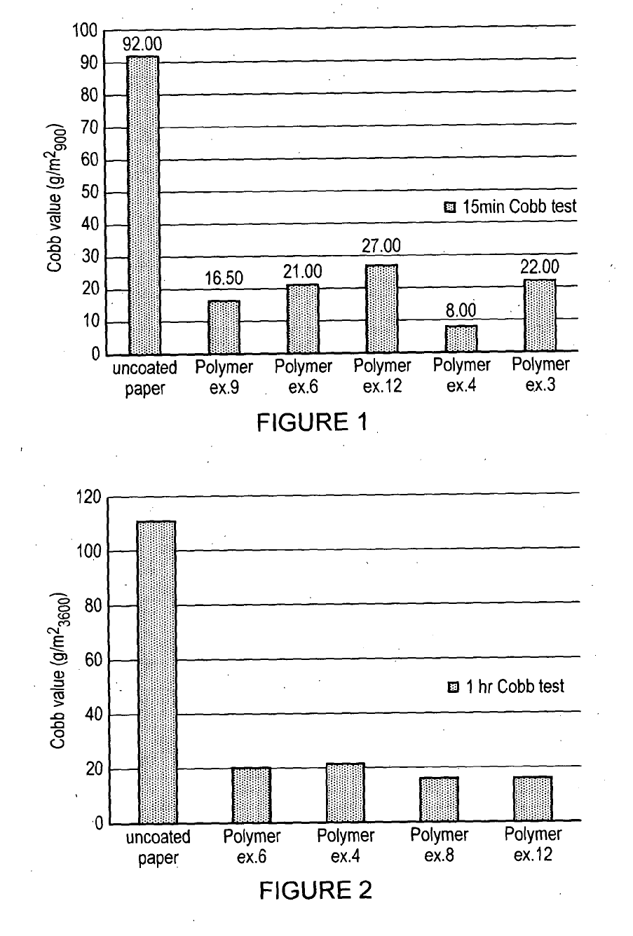

FIG. 1 shows the barrier properties of a range of polymers (polymer examples 3, 4, 6, 9, 12) and an uncoated control, where the weight increase per unit area (g/m²) is reported for a contact time of 15 minutes.

FIG. 2 shows the barrier properties of a range of polymers polymer examples 4, 6, 8, 12), and an uncoated control, where the weight increase per unit area (g/m²) is reported for a contact time of 1 hour.

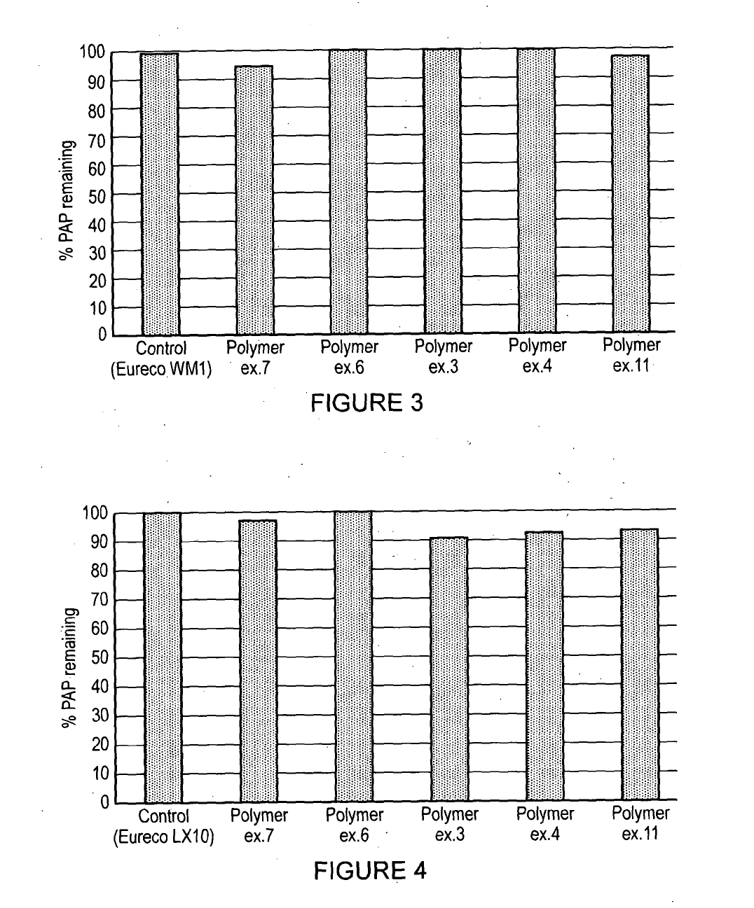

FIG. 3 shows the PAP retention in the absence of water (% remaining) for polymer examples 3, 4, 6, 7 and 11 after ageing for 30 days.

FIG. 4 shows the PAP retention in the presence of water (% remaining) for polymer examples 3, 4, 6, 7 and 11 after ageing for 30 days.

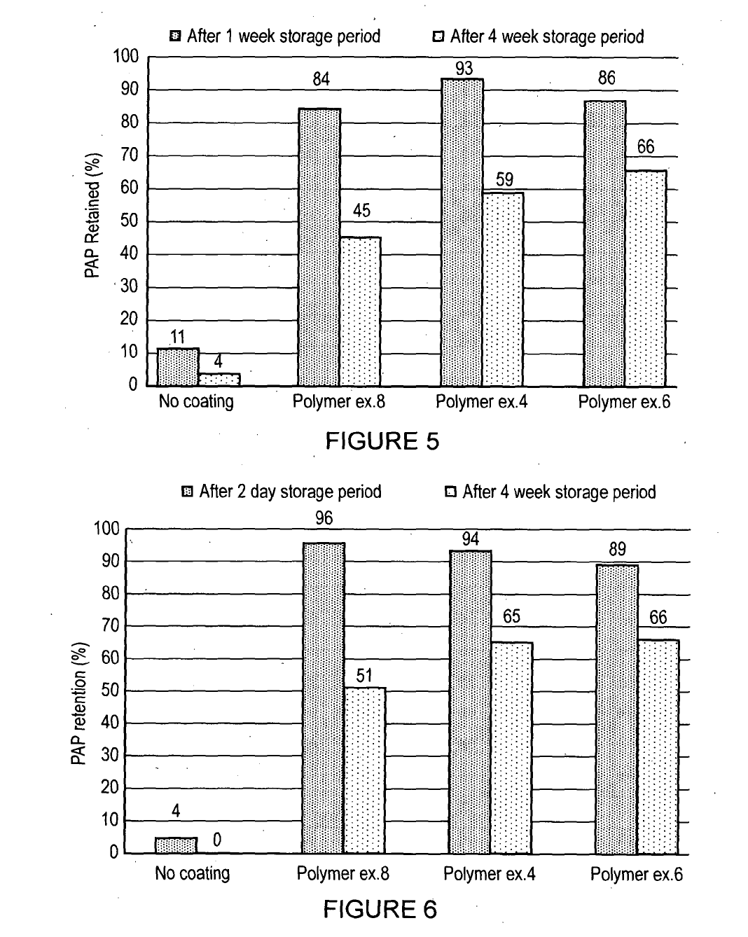

FIG. 5 shows PAP retention (% remaining) in polymer coated thimbles (polymer examples 4, 6, 8) in ADW media 2 and uncoated thimbles at both 1 week (≧84% vs. 11%) and 4 weeks storage at 40° C. (≧45% vs. 4%).

FIG. 6 shows PAP retention (% remaining) in polymer coated thimbles (polymer examples 4, 6, 8) in ADW media 1 and uncoated thimbles at both 2 days (≧89% vs. 4%) and 4 weeks storage at 40° C. (≧51% vs. 0%).

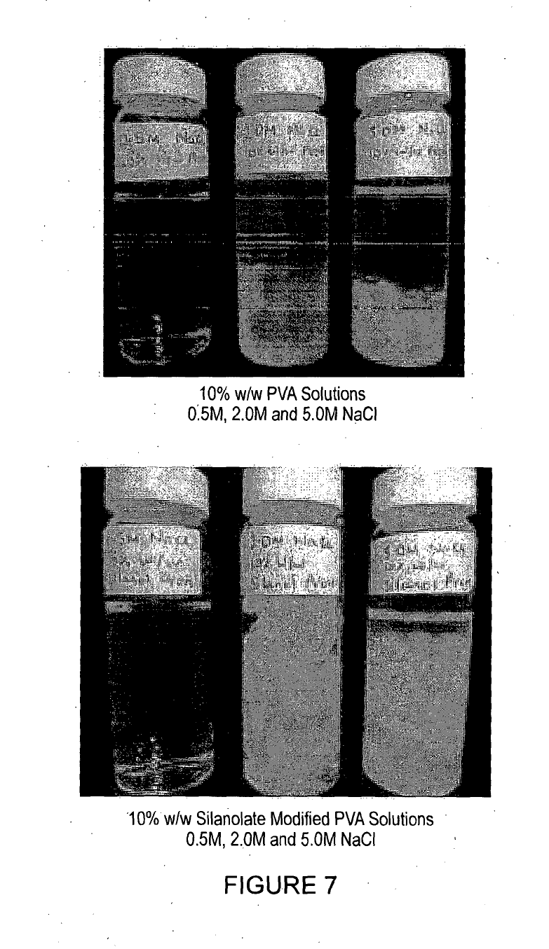

FIG. 7 shows the visual appearance of aqueous copolymer solutions (PVOH and silanolate modified PVOH).

The present invention is further described by way of the following non-limiting examples.

### EXAMPLES

### Examples of Polymers and their Composition

Polymer example 1: Exceval AQ4104¹—Ethylene Vinyl Alcohol Copolymer

Polymer example 2: K-Polymer KL506¹—Carboxyl Modified Hydrolysed Polyvinyl Acetate (PVA)

Polymer example 3: Ketoester Modified Hydrolysed Polyvinyl Acetate (PVA)

Polymer example 4: R-polymer R1130¹—Silanolate Modified Hydrolysed Polyvinyl Acetate (PVA)

Polymer example 5: Mowiol 4-98¹—Hydrolysed Polyvinyl Acetate

Polymer example 6: Mowiol 30-98¹ Hydrolysed Polyvinyl Acetate

Polymer example 7: Poly(hydroxyethylmethacrylate)

Polymer example 8: Poly(hydroxyethylmethacrylate)

Polymer example 9: Poly(hydroxyethylmethacrylate)

Polymer example 10: Poly(hydroxyethylmethacrylate)

Polymer example 11: AMPS—hydroxyethylmethacrylate Copolymer

Polymer example 12: AMPS—hydroxyethylmethacrylate Copolymer.

¹Polymer commercially available from Kuraray, Frankfurt, Germany.

### Synthesis of Copolymers

### Synthesis Protocol (1)

### Poly(Hydroxyethylmethacrylate) Homopolymer

The synthesis was performed in aqueous ethanol (50% w/w deionised water/50% w/w ethanol); the reaction solvent. Into a clean, dry, closed, jacketed glass reaction vessel fitted with an over-head stirrer, equalising pressure dropping funnel, condenser and thermocouple, in which an inert (nitrogen) atmosphere was maintained, first reaction solvent (612.0 g), then 2-hydroxyethyl methacrylate (300.0 g) and finally further reaction solvent (153.0 g) was charged. The vessel was stirred continuously under the nitrogen blanket and thermostated at 75° C. Meanwhile a solution of an azo-initiator was prepared; dimethyl 2,2′-azobis(2-methylpropionate) (5.3 g) in the reaction solvent (135.0 g); the initiator solution. This initiator solution was then added to the reaction in 4 discrete aliquots; an initial addition of 35.1 g followed by an addition of 70.2 g (after 30 minutes). Following this second addition the polymerisation reaction was allowed to proceed for a further 210 minutes, after which the reaction temperature was increased to 80° C. When the system was thermostated at 80° C., a third addition of the initiator solution (17.5 g) was made and the reaction allowed to continue for a further 120 minutes. The final addition of the dilute initiator solution (17.5 g) was then made, the reaction was allowed to proceed for a further 120 minutes and then cooled to ambient. The resulting polymer solution was removed from the reactor and labelled as product.

### Synthesis Protocol (2)

### AMPS-Hydroxyethyl Methacrylate Copolymer

The synthesis was performed in aqueous ethanol (50% w/w deionised water/50% w/w ethanol); the reaction solvent. Into a clean, dry, closed, jacketed glass reaction vessel fitted with an over-head stirrer, an equalising pressure dropping funnel, a condenser and thermocouple, in which an inert atmosphere (nitrogen) was maintained, reaction solvent (142.8 g) was charged followed by 2-acrylimidomethylpropane sulphonic acid (1.1 g), 2-hydroxyethyl methacrylate (68.9 g) and finally further reaction solvent (35.7 g). The vessel was stirred continuously under the nitrogen blanket and thermostated at 75° C. Separately a solution of an azo-initiator was prepared; dimethyl 2,2′-azobis(2-methylpropionate) (1.2 g) in reaction solvent (31.5 g); the initiator solution. The initiator solution was added to the reaction in 4 discrete aliquots; an initial addition of 8.2 g followed by an addition of 16.3 g (after 30 minutes). Following this second addition the polymerisation reaction was allowed to proceed for a further 210 minutes, after which the reaction temperature was increased to 80° C. When the system was thermostated at 80° C., a third addition of the initiator solution (4.1 g) was made and the reaction allowed to proceed for a further 120 minutes. The final addition of the dilute initiator solution (4.1 g) was then made, the reaction allowed to proceed for a further 120 minutes and then cooled to ambient. The resulting polymer solution was removed from the reactor and labelled as product.

### Synthesis Protocol (3)

### Methoxypolyethyleneglycolmethacrylate-Hydroxyethylmethacrylate Copolymer

The synthesis was performed in aqueous ethanol (50% w/w deionised water/50% w/w ethanol); the reaction solvent. Into a clean, dry, closed, jacketed glass reaction vessel fitted with an over-head stirrer, equalising pressure dropping funnel, condenser and thermocouple, in which an inert (nitrogen) atmosphere was maintained, first reaction solvent (336.0 g), then methoxypoly-ethyleneglycolmethacrylate (12.0 g), then 2-hydroxyethyl methacrylate (108.0 g) and finally further reaction solvent (84.0 g) was charged. The vessel was stirred continuously under the nitrogen blanket and thermostated at 75° C. Meanwhile a dilute solution of an azo-initiator was prepared; dimethyl 2,2′-azobis(2-methylpropionate) (1.9 g) in reaction solvent (60.0 g); the initiator solution. This initiator solution was then added to the reaction in 4 discrete aliquots; an initial addition of 15.5 g followed by one of 31.0 g after 30 minutes. The polymerisation reaction was then allowed to proceed for a further 210 minutes, after which the reaction temperature was increased to 80° C. When the system was thermostated at 80° C., a third addition of the initiator solution (7.7 g) was made and the reaction allowed to continue for a further 120 minutes. The final addition of the initiator solution (7.7 g) was then made, the reaction was allowed to proceed for a further 120 minutes and then cooled to ambient. The resulting solution was removed from the reactor and labelled as product.

### Synthesis Protocol (4)

### Methacrylic Acid-Hydroxyethylmethacrylate Copolymer

The synthesis was performed in aqueous ethanol (50% w/w deionised water/50% w/w ethanol); the reaction solvent. Into a clean, dry, closed, jacketed glass reaction vessel fitted with an over-head stirrer, equalising pressure dropping funnel, condenser and thermocouple, in which an inert (nitrogen) atmosphere was maintained, first reaction solvent (336.0 g), then 2-hydroxyethyl methacrylate (108.0 g), then methacrylic acid (12.0 g) and finally further reaction solvent (84.0 g) was charged. The vessel was stirred continuously under the nitrogen blanket and thermostated at 75° C. Meanwhile a dilute solution of an azo-initiator was prepared; dimethyl 2,2′-azobis(2-methylpropionate) (2.7 g) in reaction solvent (60.0 g); the initiator solution. This initiator solution was then added to the reaction in 4 discrete aliquots; an initial addition of 15.7 g followed by one of 31.4 g after 30 minutes. The polymerisation reaction was then allowed to proceed for a further 210 minutes, after which the reaction temperature was increased to 80° C. When the system was thermostated at 80° C., a third addition of the initiator solution (7.8 g) was made and the reaction allowed to continue for a further 120 minutes. The final addition of the initiator solution (7.8 g) was then made, the reaction was allowed to proceed for a further 120 minutes and then cooled to ambient. The resulting solution was removed from the reactor and labelled as product.

### Synthesis Protocol (5)

### Sodium Styrene Sulphonate-Hydroxyethylmethacrylate Copolymer

The synthesis was performed in aqueous ethanol (50% w/w deionised water/50% w/w ethanol); the reaction solvent. Into a clean, dry, closed, jacketed glass reaction vessel fitted with an over-head stirrer, an equalising pressure dropping funnel, a condenser and thermocouple, in which an inert atmosphere (nitrogen) was maintained, reaction solvent (336.0 g) was charged followed by 2-hydroxyethyl methacrylate (117.6 g), then sodium styrene sulphonate (2.4 g) and then finally further reaction solvent (84.0 g). The vessel was stirred continuously under the nitrogen blanket and thermostated at 75° C. Separately a solution of an azo-initiator was prepared; dimethyl 2,2′-azobis(2-methylpropionate) (2.1 g) in reaction solvent (60.0 g); the initiator solution. The initiator solution was added to the reaction in 4 discrete aliquots; an initial addition of 15.5 g followed by a second of 31.0 g (at 30 minutes). Following this second addition the polymerisation reaction was allowed to proceed for a further 210 minutes, after which the temperature was increased to 80° C. When the system was thermostated at 80° C., a third addition of the initiator solution (7.8 g) was made and the reaction allowed to continue for a further 120 minutes. The final addition of the initiator solution (7.8 g) was then made, the polymerisation allowed to continue for a further 120 minutes and then the system was cooled to ambient. The resulting polymer solution was removed from the reactor and labelled as product.

### Preparation of Core Units

Phthalimido peroxy hexanoic acid (PAP) was used as the model active agent for preparing a variety of core units. The intrinsic sensitivity of PAP to both chemical and physical stimuli, resulting in its ready decomposition, means that it is a challenging model core demanding the highest levels of technical performance, chemical compatibility of the active and the polymer, barrier to the media or components of the media as well as response to changing solvent conditions, from the encapsulating polymer system. Therefore it is anticipated that the findings detailed herein with PAP will be fully transferable not only to other peroxy acids but also to other actives in high ionic strength/low solvent activity media.

| Material Name | Material Type | Material Supplier |
|---|---|---|
| Eureco WM1 | Powder: | Solvay, Milan, Italy |
| | 70% PAP | |
| | 30% sodium sulphate | |
| Eureco MG | Granulate: | Solvay, Milan, Italy |
| | 70% PAP | |
| | 17% boric acid | |
| | 13% granulating polymer | |
| Eureco LX10 | Aqueous Suspension: | Solvay, Milan, Italy |
| | 10% PAP | |
| | 1% dispersing polymer | |

The hydroxyl-functional vinylic copolymers described in the table below were tested and found to possess suitable characteristics for encapsulating one or more solid cores in accordance with the invention.

| Material Name | Material Type |
|---|---|
| Polymer example 1 | Ethylene Vinyl Alcohol Copolymer |
| Polymer example 2 | Carboxyl Modified Hydrolysed Polyvinyl Acetate |
| | (PVA) |
| Polymer example 3 | Ketoester Modified Hydrolysed Polyvinyl Acetate |
| | (PVA) |
| Polymer example 4 | Silanolate Modified Hydrolysed Polyvinyl Acetate |
| | (PVA) |
| Polymer example 5 | Hydrolysed Polyvinyl Acetate |
| Polymer example 6 | Hydrolysed Polyvinyl Acetate |
| Polymer example 7 | Poly(hydroxyethylmethacrylate) |
| Polymer example 8 | Poly(hydroxyethylmethacrylate) |
| Polymer example 9 | Poly(hydroxyethylmethacrylate) |
| Polymer example 10 | Poly(hydroxyethylmethacrylate) |
| Polymer example 11 | AMPS-hydroxyethylmethacrylate Copolymer |
| Polymer example 12 | AMPS-hydroxyethylmethacrylate Copolymer |

These copolymers were evaluated against two commercially available high ionic strength/low water activity autodishwasher (ADW) media, details of which are given in the table below.

| Material | | |
|---|---|---|
| Name | Material Type | Main components |
| ADW | Autodishwasher | Water |
| media 1 | gel capsules | Tetrasodium Glutamate Diacetate |
| | | Protease Enzyme |
| | | Polyvinyl Alcohol |
| | | Sodium Formate |
| | | Carboxylated Polymer |
| | | C12-15 Alcohols Ethoxylated Propoxylated |
| | | Xanthan Gum |
| | | Styrene Acrylic Copolymer |
| | | Amylase Enzyme |
| | | Fragrance |
| | | Proprietary Inert Filler |
| | | 1-Octyl-2-Pyrrolidone |
| | | Zinc Sulfate |
| | | Sodium Aluminum Sulphosilicate |
| | | Calcium Chloride |
| | | Direct Blue 100 |
| | | Sodium Lauryl Sulfate (Dodecyl) |
| | | Methylisothiazolinone |
| | | Benzisothiazolinone |
| | | Potassium Chloride |
| | | Sodium Chloride |
| ADW | Autodishwasher | Sodium Bicarbonate |
| media 2 | bulk gel | Sodium Carbonate |
| | | Sodium Carbonate Peroxide |
| | | Sodium Citrate |
| | | Polyethylene glycol |
| | | TAED |
| | | Sodium Polyacrylate |
| | | Alcohol polyglycolether |
| | | Microcrystalline Cellulose |
| | | Subtilisin |
| | | Citric Acid |
| | | Tetrasodium Etidronate |
| | | Sodium Silicate |
| | | Glycerin |
| | | Amylase Enzyme |
| | | Water |
| | | Fragrance/Parfum |
| | | Aka202 Pigment Red 57:1 Red 7 |
| | | Magnesium Stearate |
| | | Benzotriazole |
| | | Acid Blue 182 |

The media were selected as representative of the extremes of ionic strength and water activity likely to be encountered in commercial autodishwasher and laundry products. The ADW media 1 have a relatively low water and high salt content and the ADW media 2 has a relatively high water and a low salt content.

### Preparation of Composites

### Composite Example (1)

### Preparation of Spheronised Composites Comprising TAED, Microcrystalline Cellulose, and Genapol® OX 070

Powdered TAED (75.00 g) was placed in the bowl of a kitchen blender. The powdered TAED was then mixed for c.a.10 seconds to break-up any agglomerated material. Microcrystalline cellulose (6.25 g) was then added into bowl and the 2 powderes mixed for c.a.10 seconds to ensure that a homogeneous mixture of the 2 solids was achieved. Meanwhile an aqueous solution of Genapol® OX 070 was prepared. Initially Genapol® OX 070, which is a solid at room temperature, was melted at 80° C. (in a laboratory oven) then molten Genapol® OX 070 (6.25 g) was dispersed in deionised water (12.50 g) to create a homogeneous solution. With continuous mixing the aqueous Genapol® OX 070 solution was progressively added to the mixture of TAED and microcrystalline cellulose to give the desired wet dough. The mixing was stopped c.a. 30 seconds after completion of the addition step to redistribute the material within the bowl using a large spatula before mixing for a further c.a. 30 seconds. The resulting wet dough was stored overnight in a closed container (to avoid any loss of water) before further processing. It was then fed continuously through the Mini Screw Exruder (at 79 rpm and fitted with a 700 μm die plate) to produce cylindrical extrudate. The cylindrical extrudate was then transferred to the Spheroniser 250 and its spheronisation executed at 1000 rpm for 150 seconds to give well rounded spheroids. The spheroids were then dried at 80° C. in a laboratory oven.

### Composite Example (2)

### Preparation of Wet Dough with TAED, Hydroxyethylcellulose and Block Copolymers of Ethylene Oxide and Propylene Oxide

Powdered TAED (75.00 g) was placed in the bowl of a kitchen blender. The powdered TAED was then mixed for c.a.10 seconds to break-up any agglomerated material. Natrosol 250HHR (6.25 g) was then added to bowl and the 2 powderes mixed for a further c.a.10 seconds to ensure that a homogeneous mixture of the 2 solids was achieved. Meanwhile an aqueous solution of Pluronic L101 was prepared. Pluronic L101 (6.25 g) was dispersed in deionised water (12.50 g) to create a homogeneous solution. With continuous mixing the aqueous Pluronic L101 solution was added progressively to the mixture of TAED and Natrosol 250HHR to give the desired wet dough. The mixing was stopped c.a.30 seconds after completion of the addition step to redistribute the material within the bowl using a large spatula before mixing for a further c.a.30 seconds. Initial qualitative assessment of this wet dough confirmed that it had excellent consistency, as it could be molded, yet broken down (or crumbled), in the hand and easily extruded through a laboratory test sieve to give well formed extrudate.

### Composite Example (3)

### Spray Coating Spheronised Cores with Poly(Hydroxyethylmethacrylate)

A spheronised core material was classified, using laboratory test sieves, to give a size fraction of ≦1000 μm. The spheronised core (50 g) of the specified size was introduced into the product bowl of a Mini-Glatt fluid bed system (Glatt Process Technology, Binzen, Germany) and fluidised at a controlled bed pressure of 0.60 to 0.65 Bar with an inlet air temperature of 33.0 to 35.0° C. Into the resulting fluidised bed a 5.0% w/w ethanol/water solution of poly(hydroxyethylmethacrylate) (Polymer example 10) (200 g) was introduced by bottom spray coating (using a 0.5 mm jet, 0.5 Bar jet pressure and a Wurster extension of 55 mm) over a period of 3 hours. Consideration of the mass balance confirmed a yield of >98% with the resulting composite comprising spheronised core (83%) and poly(hydroxyethylmethacrylate) (17%).

### Testing of Copolymer and Copolymer Film Characteristics

Polymer film characteristics were determined in order to identify those materials capable of acting as an effective and robust barrier against the test media, whilst being vulnerable to the wash liquor.

The following tests were applied:
1. Chemical resistance testing (using the test media as supplied).
2. Chemical release testing (using dilute test media).
3. Chemical resistance testing (using solutions of varying ionic strength).
4. Cobb testing.
5. Compatibility testing.
6. Solution characteristics (of ionic strength-responsive polymers).

### Chemical Resistance Testing (Detergent Media)

The purpose of this test was to evaluate the integrity of the polymer films after their exposure to the test media, under specified conditions for a controlled time, after which the media is removed and the integrity of the film evaluated. The following pass/fail criteria were applied:

Pass: the film remained intact during the test.
Fail: a negative effect on the integrity of the film; the film may have softened or dissolved.

The results of chemical resistance testing, where the media is contacted with the polymer films for 17 hours at 40° C. are given in the table below.

| | | Performance | |
|---|---|---|---|
| | | ADW | ADW |
| Polymer Class | Reference | media 1 | media 2 |
| Ethylene Vinyl Alcohol | Polymer example 1 | Pass | Pass |
| Copolymer | | | |
| Carboxyl Modified PVA | Polymer example 2 | Pass | Pass |
| Ketoester Modified PVA | Polymer example 3 | Pass | Pass |
| Silanolate Modified PVA | Polymer example 4 | Pass | Pass |
| PVA | Polymer example 5 | Pass | Fail |
| | Polymer example 6 | Pass | Pass |
| Poly(hydroxyethylmethacrylate) | Polymer example 7 | Pass | Pass |
| | Polymer example 9 | Pass | Pass |
| | Polymer example 8 | Pass | Pass |
| AMPS- | Polymer example 11 | Pass | Pass |
| hydroxyethylmethacrylate | Polymer example 12 | Pass | Pass |

The results confirm that in general the hydroxyl-functional vinylic copolymer films evaluated demonstrate excellent chemical resistance to both media under the stated test conditions.

Further testing was performed on selected hydroxyl-functional vinylic copolymer films, where the polymer films were in intimate contact with the media for 1 week and 2 weeks at 40° C. The results are reported in the table below.

| | | Performance at | | Performance at | |
|---|---|---|---|---|---|
| | | 1 week | | 2 weeks | |
| Polymer | | ADW | ADW | ADW | ADW |
| Class | Reference | media 1 | media 2 | media 1 | media 2 |
| Ethylene Vinyl | Polymer | Pass | Pass | Pass | Pass |
| Alcohol | example 1 | | | | |
| Copolymer | | | | | |
| Ketoester | Polymer | Pass | Pass | Pass | Pass |
| Modified PVA | example 3 | | | | |
| Silanolate | Polymer | Pass | Pass | Pass | Pass |
| Modified PVA | example 4 | | | | |
| PVA | Polymer | Pass | Pass | Pass | Pass |
| | example 6 | | | | |
| Poly(hydroxyethyl- | Polymer | Pass | Fail | Pass | Fail |
| methacrylate) | example 7 | | | | |
| | Polymer | Pass | Fail | Pass | Fail |
| | example 9 | | | | |
| | Polymer | Pass | Pass | Pass | Pass |
| | example 8 | | | | |
| AMPS- | Polymer | Pass | Fail | Pass | Fail |
| hydroxyethyl- | example 11 | | | | |
| methacrylate | Polymer | Pass | Pass | Pass | Fail |
| | example 12 | | | | |

The results confirm that in general the hydroxyl-functional vinylic copolymer films evaluated demonstrate excellent chemical resistance under the extended test conditions.

### Chemical Release Testing

The purpose of this test was to evaluate the vulnerability of the hydroxyl-functional vinylic copolymer films to dissolution in the wash environment and so release the protected active agent; i.e. to test the release characteristics. In order to evaluate the release characteristics the test media were diluted with water to a concentration equivalent to the maximum recommended dosage of each product so giving wash liquors with highest anticipated ionic strengths and lowest anticipated water activity; i.e. the most demanding release conditions. The dilutions are detailed in the table below. All dilutions were conducted with de-ionised water.

| Media | Wash Liquor |
|---|---|
| ADW media 1 | 7.3 g ADW media 1per litre of water |
| ADW media 2 | 10 g ADW media 2 per litre of water |

Polymer films were exposed to the dilute wash liquors for 30 minutes at 30° C.

The following pass/fail criteria were applied:

Pass: The film dissolves or “releases”.
Pass¹: The film is swollen, softened and damaged, but largely remains on the substrate.
Fail: The physical properties of the film are unchanged.

It is anticipated that films giving a Pass or Pass¹ results will permit release of an active from a polymer encapsulate core material into the surrounding media.

The results of chemical release testing on a range of films are in the table below.

| | | Release | |
|---|---|---|---|
| | | Dilute | Dilute |
| Polymer Class | Reference | Gelpacs | Gel |
| Ethylene Vinyl Alcohol Copolymer | Polymer | Pass¹ | Pass¹ |
| | example 1 | | |
| Carboxyl Modified PVA | Polymer | Pass | Pass |
| | example 2 | | |
| Ketoester Modified PVA | Polymer | Pass | Pass |
| | example 3 | | |
| Silanolate Modified PVA | Polymer | Pass | Pass |
| | example 4 | | |
| PVA | Polymer | Pass | Pass |
| | example 5 | | |
| | Polymer | Pass | Pass |
| | example 6 | | |
| Poly(hydroxyethylmethacrylate) | Polymer | Pass¹ | Pass¹ |
| | example 7 | | |
| | Polymer | Pass¹ | Pass¹ |
| | example 9 | | |
| | Polymer | Pass¹ | Pass¹ |
| | example 8 | | |
| AMPS-hydroxyethylmethacrylate | Polymer | Pass | Pass |
| | example 11 | | |
| | Polymer | Pass¹ | Pass¹ |
| | example 12 | | |

The results confirm that in general the hydroxyl-functional vinylic copolymer films evaluated demonstrate excellent chemical release characteristics under the test conditions.

### Chemical Resistance Testing (Ionic Strength)

The purpose of this test was to evaluate the physical integrity of the hydroxyl-functional vinylic copolymer films after exposure to salt solutions of different concentrations (and thus ionic strength), water, 0.5M, 2.0M, 4.0M and 8.0M sodium chloride, for 17 hours at 40° C.

The following pass/fail criteria were applied:

Pass: the film remained intact during the test.
Fail: a negative effect on the integrity of the film, where the film may have softened or completely dissolved.

The results are given in the table below.

| | | Chemical Resistance | | | |
|---|---|---|---|---|---|
| | | | 0.5M | 2.0M | 4.0M |
| Polymer Class | Reference | Water | NaCl | NaCl | NaCl |
| Ethylene Vinyl Alcohol | Polymer | Fail | Fail | Pass | Pass |
| Copolymer | example 1 | | | | |
| Carboxyl Modified PVA | Polymer | Fail | Fail | Fail | Fail |
| | example 2 | | | | |
| Ketoester Modified PVA | Polymer | Fail | Fail | Fail | Fail |
| | example 3 | | | | |
| Silanolate Modified PVA | Polymer | Fail | Fail | Fail | Fail |
| | example 4 | | | | |
| PVA | Polymer | Fail | No data | No data | No |
| | example 5 | | | | data |
| | Polymer | Fail | No data | No data | No |
| | example 6 | | | | data |
| Poly(hydroxyethylmethacrylate) | Polymer | Fail | Fail | Pass | Pass |
| | example 7 | | | | |
| | Polymer | Fail | No data | No data | No |
| | example 9 | | | | data |
| | Polymer | Pass | No data | No data | No |
| | example 8 | | | | data |
| AMPS- | Polymer | Fail | No data | No data | No |
| hydroxyethylmethacrylate | example 11 | | | | data |

The data presented in the table above confirm that the hydroxyl-functional vinylic copolymer films fall into three distinct categories:
1. Films that fail against water and all considered salt solutions; e.g. carboxyl modified PVA (Polymer example 2);
2. Films that fail against water and the lower concentration salt solutions, but pass against higher concentration salt solutions; e.g. ethylene vinyl alcohol copolymer (Polymer example 1); and
3. Films that pass against water and all salt solutions; e.g. poly(hydroxyethylmethacrylate) (Polymer example 8).

A number of hydroxyl-functional vinylic copolymers have been identified, from the chemical resistance and release testing, that are physically robust to the test media (product environment) yet vulnerable to the dilute test media (wash environment); i.e. polymers demonstrating a response to ionic strength and water activity. They are:
1. Hydrolysed polyvinyl acetate.
2. Ethylene vinyl alcohol copolymer.
3. Ketoester modified hydrolysed polyvinyl acetate.
4. Silanolate modified hydrolysed polyvinyl acetate
5. Poly(hydroxylethylmethyacrylate).

### Cobb Testing

The purpose of the Cobb test is to evaluate the barrier properties of the hydroxyl-functional vinylic copolymer film. The test is widely used to assess the water absorptiveness of sized and coated papers, paperboards and fibreboards, (see method T441 om-09 of the Technical Association of the Pulp & Paper Industry (TAPPI)), and is readily adapted to permit assessment of barrier to other liquid media such as the Gelpacs and Gel.

In order to ensure the chemical and physical isolation of peroxy acid bleaches, or other active agents, from the bulk of the liquid laundry or autodishwash detergent, it is critical that a significant barrier is presented by the hydroxyl-functional vinylic copolymer film to prevent ingress of the media, or components of the media, that may adversely impact the various actives.

A 20 μm copolymer film was first cast onto a paper substrate. The film was then exposed to the Gel test media under controlled conditions; temperature, contact area, volume of test media and contact time. Media, or any of its components, penetrating through the copolymer film were absorbed by the paper substrate, which was observed as a weight increase. Thus a small weight increase was indicative of a good barrier.

The barrier properties of a range of polymers, and an uncoated control, are presented in FIG. 1, where the weight increase per unit area (g/m²) is reported for a contact time of 15 minutes.

The hydroxyl-functional vinylic copolymers tested were as follows:
1. Polymer example 9 is a poly(hydroxyethylmethyacrylate)
2. Polymer example 6 is a hydrolysed polyvinyl acetate.
3. Polymer example 12 is an AMPS-hydroxyethylmethacrylate.
4. Polymer example 4 is a silanolate modified hydrolysed polyvinyl acetate.
5. Polymer example 3 is a ketoester modified hydrolysed polyvinyl acetate.

In each case a significant barrier is created by the applied 20 μm polymer film.

When the contact time was extended to 1 hour, maintenance of a robust and significant barrier was observed, as detailed in FIG. 2, wherein:
1. Polymer example 6 is a hydrolysed polyvinyl acetate.
2. Polymer example 4 is a silanolate modified hydrolysed polyvinyl acetate.
3. Polymer example 8 is a poly(hydroxyethylmethyacrylate).
4. Polymer example 12 is an AMPS-hydroxyethylmethacrylate

### Compatibility Testing

The aim of this test was to evaluate the chemically compatibility of the active agent and the hydroxyl-functional vinylic copolymers. The active agent and the copolymer should form an inert mixture, where the compatibility is evaluated in the absence and presence of water. The PAP/copolymer mixtures were aged under controlled conditions and their PAP content followed as a function of time. The PAP content of the mixtures was determined by iodometric titration, which conveniently gives a clear visual response, colour change, indicative of the chemical activity of the peroxy acid bleach (so confirming its retention in the desired form). The PAP and polymer are said to be compatible, if the PAP retention is >90% after ageing for 30 days under ambient conditions.

### Evaluation in the Absence of Water:

Eureco WM1 was agglomerated with a 10% w/w polymer solution, using a kitchen blender, and allowed to dry overnight under ambient conditions. The resulting samples were stored in plastic (HDPE) containers under ambient conditions. A control sample, Eureco WM1 alone, was also executed in parallel to the described agglomerates. Samples were taken at regular intervals for PAP assay.

The retention of PAP after ageing for 30 days is presented in FIG. 3, where:
1. Polymer example 7 is a poly(hydroxyethylmethyacrylate).
2. Polymer example 6 is a hydrolysed polyvinyl acetate.
3. Polymer example 3 is a ketoester modified hydrolysed polyvinyl acetate.
4. Polymer example 4 is a silanolate modified hydrolysed polyvinyl acetate.
5. Polymer example 12 is an AMPS-hydroxyethylmethacrylate.

A high level of PAP was observed (≧94%); i.e. the PAP and the identified copolymers were compatible.

### Evaluation in the Presence of Water:

Eureco LX10 and 10% w/w polymer solutions were mixed to obtain a uniform dispersion. The samples were stored in plastic (HDPE) containers under ambient conditions. A control, Eureco LX10 alone, was also executed in parallel to the described dispersions. Samples were taken at regular intervals for PAP assay.

The retention of PAP after ageing for 30 days is presented in FIG. 4, where:
1. Polymer example 7 is a poly(hydroxyethylmethyacrylate).
2. Polymer example 6 is a hydrolysed polyvinyl acetate.
3. Polymer example 3 is a ketoester modified hydrolysed polyvinyl acetate.
4. Polymer example 4 is a silanolate modified hydrolysed polyvinyl acetate.
5. Polymer example 12 is an AMPS-hydroxyethylmethacrylate.

Per the stated definition, the following copolymers are deemed to be compatible with PAP:
1. Poly(hydroxyethylmethyacrylate).
2. Hydrolysed polyvinyl acetate PVOH.
3. Ketoester modified hydrolysed polyvinyl acetate.
4. Silanolate modified hydrolysed polyvinyl acetate.
5. AMPS-hydroxyethylmethacrylate.

### Solution Characteristics

The visual appearance of aqueous solutions of hydroxyl-functional vinylic copolymers was assessed as a function of salt concentration (sodium chloride); at 10.0% w/w copolymer and up to 5.0M concentration of sodium chloride. Their appearance was observed as a function of the salt concentration; i.e. ionic strength. In water, clear homogeneous solutions were observed; however, with increasing salt concentration the copolymer solutions were encountered as gels. Precipitation of the copolymer was observed as the salt concentration was further increased.

This behaviour is illustrated in FIG. 7.

Barrier Testing with Bleach Active.

This test method was developed to determine the effectiveness of the polymer to perform as a barrier to the media, when cast onto a substrate (cellulose thimble), to protect PAP after storage in the presence of the test media. Key steps in the tested method are:
1. The polymer coated thimbles were prepared first where the thimbles were dipped into the polymer solution (10.0% solids), and then dried at 80° C. This was repeated until 5 dips were complete. (Note: the thimble was weighed before and after the coating was complete to calculate the coat weight on the thimble).
2. The polymer coated thimbles are conditioned (16 hours/ambient conditions) prior to their evaluation.
3. Eureco WM1 was then weighed into the thimble, and the thimble placed into the test media (ADW media 1 or 2).
4. These samples were then sealed and stored in an oven at 40° C. for up to 1 month.
5. The Eureco WM1 remaining in the thimble after testing is weighed and then the PAP content of said sample is measured through iodometric titration.

The remaining sample weight and PAP level in each sample is determined. Further calculations are performed on this data to determine the level of PAP remaining versus that in the original sample. The following results were produced by storing the thimbles in ADW media 1 and 2.

FIG. 5 shows that the retention of PAP in the polymer coated thimbles in ADW media 2 is many times greater than in the uncoated thimbles at both 1 week (≧84% vs. 11%) & 4 weeks (≧45% vs. 4%) with the highest retention levels observed with the partially hydrolysed polyvinyl acetate (polymer example 6).

FIG. 6 shows the retention of PAP in the polymer coated thimbles in ADW media 1 is many times greater than in the uncoated thimbles at both 2 days (≧89% vs. 4%) & 4 weeks (≧51% vs. 0%) with the highest retention levels (at 4 weeks) observed with the modified partially hydrolysed polyvinyl acetate (Polymer example 4) & partially hydrolysed polyvinyl acetate (Polymer ex.6).

Various modifications and variations of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the relevant fields are intended to be covered by the present invention.

1. A composite comprising one or more core units having an ionic strength-responsive hydroxyl-functional vinylic co-polymeric coating.

2. A composite according to claim 1, wherein the core units are solid.

3. A composite according to claim 1, wherein the core units comprise single discrete particles, agglomerated particles, matrix particles and/or spheronised compositions.

4. A composite according to claim 1, wherein the ionic strength-responsive hydroxyl-functional vinylic co-polymeric coating is insoluble at high ionic strengths yet soluble at low ionic strengths.

5. A composite according to claim 4, wherein the ionic strength-responsive hydroxyl-functional vinylic co-polymeric coating is insoluble under conditions of low water activity yet soluble under conditions of high water activity.

6. A composite according to claim 5, wherein the ionic strength-responsive hydroxyl-functional vinylic co-polymer has an empirical structural formula (4):
—[A]ₘ[B]ₙ[C]ₚ— (4)
wherein,
[A] is an optional component and represents moieties which are essentially hydrophobic;
[B] is an optional component and represents moieties which are essentially polar and that have strong interaction with water;
[C] is an essential component which contains one or more hydroxyl functionalities; and m, n and p represent the percentage molar fraction of components [A], [B] and [C] respectively, such that m+n+p=100%.

7. A composite according to claim 6, wherein component [A] corresponds to formula (5): 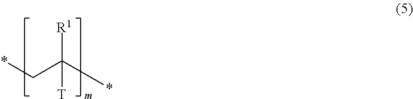
wherein each R¹ is H or CH₃;
each T is H, —OC(O)R², —C(O)OR², C₆-aromatic aryl or C₃₋₂₀ cycloalkyl optionally substituted by one of more C₁₋₆ alkyl groups; and
each R² is linear or branched C₁₋₂₀ alkyl, or C₃₋₂₀ cycloalkyl optionally substituted by one or more C₁₋₆ alkyl groups.

8. A composite according to claim 6, wherein component [B] corresponds to formula (6): 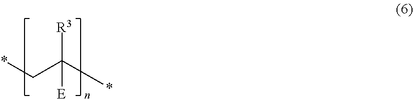
wherein each R³ is H or CH₃;
E is selected from —OC(O)CH₂C(O)CH₃, —CN, —C(O)OCH₂CHR⁴OR⁵, —C(O)OH, —C(O)CH₂CH₂CO₂H, —C(O)OM, —C(O)CH₂CH₂CH₂SO₃M, C(O)NHC(CH₃)₂CH₂SO₃H, —C(O)NHC(CH₃)₂CH₂SO₃M, —C(O)CH₂CH₂CO₂M, OCH₂CH₂OC(O)CH₂C(O)CH₃, —C(O)OM, —C(O)(OCH₂CH₂)_{F}OR⁵, —Si(OM)₃, —OCH₂CH₂NR⁴, —C(O)NH₂, and —C(O)NMe₂;
M is a monovalent alkali metal;
each R⁴ is H or CH₃;
each R⁵ is H or C₁₋₄ alkyl; and
F is an integer from 2 to 20.

9. A composite according to claim 6, wherein component [C] corresponds to formula (7): 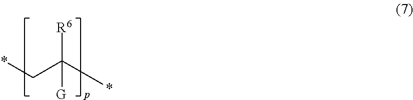
wherein, R⁶ is H or CH₃;
G is selected from —OH, —C(O)OCH₂CH₂OH, —C(O)OCHOHCH₂OH, —C(O)(OCH₂CH₂)_{F}OH, —C(O)OCH₂CHR⁷OH, —C(O)O(CH₂)₄OH, and —C(O)NR⁷CH₂OH;
R⁷ is H or CH₃; and
F is an integer from 2 to 20.

10. A composite according to claim 6, wherein the ionic strength-responsive hydroxyl-functional vinylic co-polymer is selected from partially hydrolysed polyvinyl acetate, fully hydrolysed polyvinyl acetate, silanolate modified hydrolysed polyvinyl acetate, ketoester modified hydrolysed polyvinyl acetate, carboxyl modified hydrolysed polyvinyl acetate, poly(hydroxyethyl-methyacrylate), poly(AMPS-hydroxyethylmethacrylate) and ethylene vinyl alcohol copolymer.

11. A composite according to claim 1, wherein the core units comprise one or more active agents.

12. A composite according to claim 11, wherein the active agent is selected from the group consisting of bleaching agents, bleach activators, anti-foaming agents, anti-redeposition aids, anti-microbials and biocides, enzymes, bleach catalysts, dye transfer inhibitors, optical brighteners, dyes, pigments, anti-scale and corrosion inhibiting ingredients, fragrances and perfumes, glass protectors, crop protection agents and argochemicals.

13. A process for preparing a composite according to claim 1, which process comprises applying an ionic strength-responsive hydroxyl-functional vinylic co-polymeric coating to the surface of one or more core units.

14. A composition comprising a composite according to claim 1 and one or more active and/or non-active agents.

15. A solid or liquid auto-dishwasher product, which comprises a composite according to claim 1.

16. A solid or liquid auto-dishwasher product according to claim 15 comprising from about 0.5% to about 25% by weight of the composite.

17. A solid or liquid auto-dishwasher product according to claim 15, comprising an active agent selected from a bleaching agent, bleach activator or an enzyme, or a mixture thereof.

18. A solid or liquid laundry product comprising a composite according to claim 1.

19. A solid or liquid laundry product according to claim 18 comprising from about 0.5% to about 25% by weight of the composite.

20. A solid or liquid laundry product according to claim 18, comprising an active agent selected from a bleaching agent, bleach activator, enzyme, fragrance or perfume, or a mixture thereof.
